(19) United States
(12) Patent Application Publication
(10) Pub. No.: US 2009/0089076 A1
(43) Pub. Date: Apr. 2, 2009

(54) Image forming apparatus, method of registering information of replacement component, and computer program product

(75) Inventors: Hiroki Asakimori, Saitama (JP); Junji Ukegawa, Kanagawa (JP); Mayu Kondo, Chiba (JP); Yutaka Yagiura, Kanagawa (JP); Takashi Soyama, Saitama (JP); Hiroshi Kobayashi, Kanagawa (JP); Nahoko Yano, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/232,087

(22) Filed: Sep. 10, 2008

(30) Foreign Application Priority Data
Sep. 14, 2007 (JP) 2007-239629

(51) Int. Cl. G06Q 99/00

(52) U.S. Cl. 705/1

(57) ABSTRACT

An image forming apparatus includes a plurality of replacement components to be replaced according to their lifetimes. An information setting unit sets a replacement type of each of the replacement components, which indicates whether each of the replacement components is to be replaced at failure or replaced periodically, and a replacer who is in charge of replacing each of the replacement components. An information registering unit registers therein the replacement type and the replacer set by the information setting unit for each of the replacement components.

### CROSS-REFERENCE TO RELATED APPLICATIONS

The present application claims priority to and incorporates by reference the entire contents of Japanese priority document 2007-239629 filed in Japan on Sep. 14, 2007.

### BACKGROUND OF THE INVENTION

1. Field of the Invention

The present invention relates to an image forming apparatus, a method of registering information of replacement components, and a computer program product.

2. Description of the Related Art

An image forming apparatus includes a plurality of replacement components (parts or units) in working portions that performs operations related to image formation. These replacement components need to be replaced according to their lifetimes.

Hence, Japanese Patent Application Laid-open No. 2005-234316 proposes a method in which, to determine the lifetime of a unit including replacement components (constituent elements), “unit replacement” is displayed when any one of the replacement components that constitute the unit reaches the end of lifetime.

The replacement components are usually replaced by service engineer (customer engineer), while users themselves are sometimes asked to replace some of the replacement components that can be relatively easily and safely replaced. Such a service called “customer replaceable unit (CRU) service” is already known.

The CRU service enables to ask the users to replace components, which reduces downtime of machines. Furthermore, the service cost can be reduced, and therefore a less expensive service menu can be provided to the users.

However, in the typical CRU service, components that can be replaced by the users are fixed in advance. A unit of replacement (such as each unit, and each part) is also fixed with respect to each model.

Therefore, it is impossible to increase or decrease the number of CRU components according to operating manners of the users, or switch the unit of replacement between each unit and each part according to the countries or regions. Accordingly, services appropriate for each user cannot be provided.

### SUMMARY OF THE INVENTION

It is an object of the present invention to at least partially solve the problems in the conventional technology.

According to one aspect of the present invention, there is provided an image forming apparatus including a plurality of replacement components. The image forming apparatus further includes a information setting unit that sets a replacement type of each of the replacement components, which indicates whether each of the replacement components is to be replaced at failure or replaced periodically, and a replacer who is in charge of replacing each of the replacement components; and an information registering unit that registers therein the replacement type and the replacer set by the information setting unit for each of the replacement components.

Furthermore, according to another aspect of the present invention, there is provided a method of registering information of a replacement component in an image forming apparatus that includes a plurality of replacement components. The method includes setting a replacement type of each of the replacement components, which indicates whether each of the replacement components is to be replaced at failure or replaced periodically, and a replacer who is in charge of replacing each of the replacement components; and registering the replacement type and the replacer set at the setting for each of the replacement components.

Moreover, according to still another aspect of the present invention, there is provided a computer program product including a computer-usable medium having computer-readable program codes embodied in the medium for registering information of a replacement component in an image forming apparatus that includes a plurality of replacement components. The program codes when executed cause a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a hardware configuration example of an image forming apparatus according to a first embodiment of the present invention;

FIG. 2 is a block diagram of a configuration example of software in the image forming apparatus according to the first embodiment;

FIGS. 3A to 3C are schematic diagrams of examples of a plurality of operation screens including a replacement-parts list screen for service engineer, displayed on an operating unit shown in FIG. 1;

FIG. 4 is a setting information table stored in a nonvolatile memory in FIG. 1 as one example;

FIG. 5 is a flowchart of an example of a service-setting menu process performed by a central processing unit (CPU) in FIG. 1;

FIG. 6 is a flowchart of an example of a subroutine of a service setting process at Step S5 in FIG. 5;

FIG. 7 is a flowchart of an example of a subroutine of a setting update process (A) at Step S13 in FIG. 6;

FIG. 8 is a flowchart of an example of a subroutine of a periodical-replacement update process (B) at Step S22 in FIG. 7;

FIG. 9 is a flowchart of an example of a subroutine of a current-value clearing process at Step S23 in FIG. 7;

FIG. 10 is a flowchart of an example of a current-value update process performed by the CPU shown in FIG. 1;

FIG. 11 is a flowchart of an example of a subroutine of a replacement-time determining process at Step S4 in FIG. 5 and Step S54 in FIG. 10;

FIG. 12 is a flowchart of an example of a subroutine of an end determining process at Step S62 in FIG. 11;

FIG. 13 is a flowchart of an example of a subroutine of an end process (A) at Step S74 in FIG. 12;

FIG. 14 is a flowchart of an example of a subroutine of a near-end process (B) at Step S73 in FIG. 12;

FIG. 15 is a schematic diagram of examples of relations of main and sub components in an image forming apparatus according to a second embodiment of the present invention;

FIGS. 16A to 16F are schematic diagrams of examples of a plurality of operation screens including a replacement-parts list screen for service engineer in consideration of main and sub components displayed on the operating unit as shown in FIG. 1;

FIG. 17 is a setting information table in consideration of a relation between main and sub components stored in the nonvolatile memory as shown in FIG. 1 as one example;

FIG. 18 is a flowchart of another example of a subroutine of the service setting process shown in FIG. 5;

FIG. 19 is a flowchart of an example of a subroutine of a setting update process (A) at Step S103 in FIG. 18;

FIG. 20 is a flowchart of an example of a subroutine of an update determining process (B) at Step S112 in FIG. 19;

FIG. 21 is a flowchart of an example of a subroutine of a periodical-replacement update process (C) at Step S125 in FIG. 20;

FIGS. 22A and 22B are schematic diagrams of examples of notification displayed when periodical replacement setting of a main component is changed;

FIG. 23 is a flowchart of an example of a subroutine of a main component usage-update process at Steps S114 and S119 in FIG. 19;

FIG. 24 is a flowchart of an example of a subroutine of a replacement completing process at Step S115 in FIG. 19;

FIG. 25 is a flowchart of another example of the current-value update process performed by the CPU shown in FIG. 1;

FIGS. 26A to 26D are schematic diagrams of examples of a plurality of operation screens including replacement-parts list screens and a collective setting screen for service engineer in consideration of main and sub components displayed on the operating unit as shown in FIG. 1;

FIG. 27 is a flowchart of an example of a service-setting menu process in consideration of collective setting performed by the CPU shown in FIG. 1;

FIG. 28 is a flowchart of an example of a subroutine of a collective setting process at Step S176 in FIG. 27;

FIG. 29 is a flowchart of an example of a subroutine of a periodical-replacement collective-setting process at Step S183 in FIG. 28;

FIGS. 30A and 30B are schematic diagrams of examples of notification for confirming execution, displayed when periodical-replacement collective setting is selected;

FIG. 31 is a flowchart of an example of a subroutine of a replacer collective-setting process at Step S184 in FIG. 28;

FIGS. 32A and 32B are schematic diagrams of examples of notification for confirming execution, displayed when a replacer collective-setting process is selected;

FIG. 33 is a flowchart of an example of a subroutine of a replacement-unit collective-setting process at Step S185 in FIG. 28;

FIGS. 34A and 34B are schematic diagrams of examples of notification for confirming execution, displayed when replacement-unit collective setting is selected;

FIGS. 35A to 35D are schematic diagrams of examples of an initial-setting menu screen and a plurality of periodical-replacement-parts list screens, displayed on the operating unit shown in FIG. 1;

FIG. 36 is a setting information table in consideration of a periodical-replacement-parts list screen display stored in the nonvolatile memory in FIG. 1 as one example;

FIGS. 37A to 37C are schematic diagrams of examples of a periodical-replacement-parts list screen and a plurality of setting screens, displayed on the operating unit shown in FIG. 1;

FIG. 38 is a flowchart of an example of a user-setting menu process performed by the CPU shown in FIG. 1;

FIG. 39 is a flowchart of an example of a subroutine of a report setting process at Step S236 in FIG. 38;

FIG. 40 is a flowchart of an example of a subroutine of a user setting process at Step S237 in FIG. 38; and

FIG. 41 is a flowchart of an example of a subroutine of a setting update process (A) at Step S253 in FIG. 40.

### DETAILED DESCRIPTION OF THE PREFERRED EMBODIMENTS

Exemplary embodiments of the present invention will be explained below in detail with reference to the accompanying drawings.

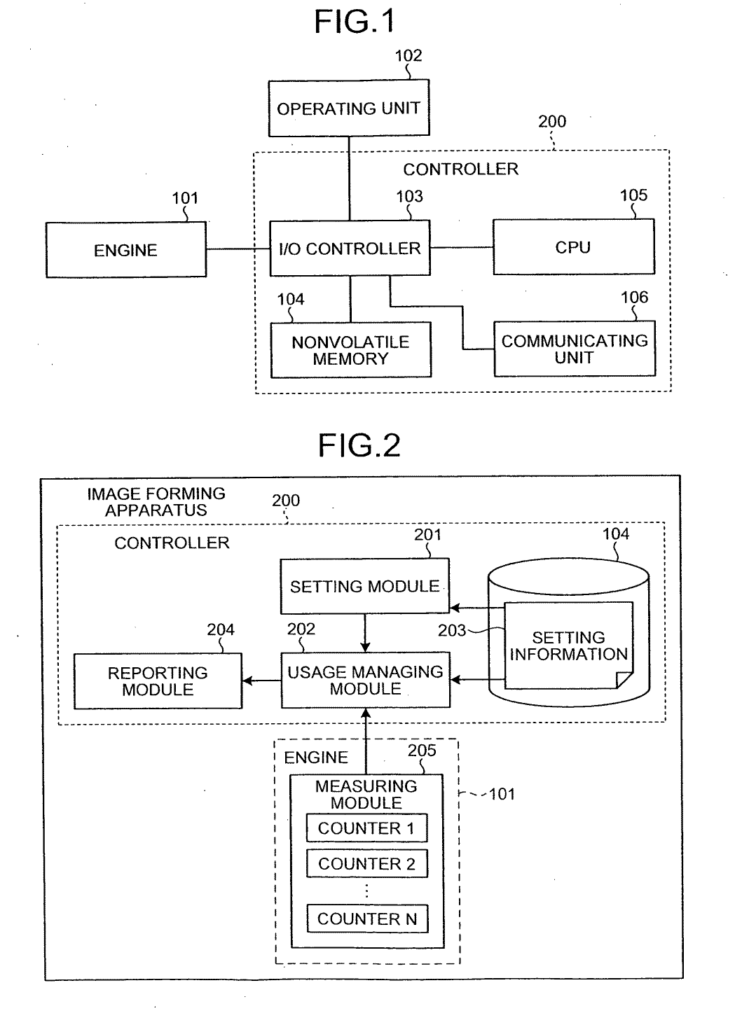

FIG. 1 is a block diagram of a hardware configuration example of an image forming apparatus according to a first embodiment of the present invention.

The image forming apparatus includes an engine 101, an operating unit 102, an input/output (I/O) controller 103, a nonvolatile memory 104, a CPU 105, a communicating unit 106, and the like. Among these units, the I/O controller 103, the nonvolatile memory 104, the CPU 105, and the communicating unit 106 constitute a controller 200.

The engine 101 performs an operation related to image formation, and forms images on a medium, such as paper.

The operating unit 102 is a user interface (UI) for providing functions to a user, or notifying the user of a status of the apparatus. The operating unit 102 includes an input unit including various operation keys (also called “operation switches” or “operation buttons”) that enable to input data, such as selection of a function and an operation instruction to the engine 101 based on the selection. The operating unit 102 further includes a display unit that displays the status of the apparatus and the like, such as a liquid crystal display (LCD) and a cathode ray tube (CRT).

The I/O controller 103 controls input to or output from the outside, such as the engine 101 and the operating unit 102.

The nonvolatile memory 104 stores therein various data, for example, a computer program (software) such as firmware executed by the CPU 105, and a status or information of the image forming apparatus, and can hold the data even when the power is cut off. The nonvolatile memory 104 corresponds to a nonvolatile storage medium, such as a flash memory and a hard disk drive (HDD).

The CPU 105 operates according to the computer program in the nonvolatile memory 104 (executes the computer program), thereby controlling the entire apparatus.

The communicating unit 106 corresponds to a network interface (I/F) or a modem. The communicating unit 106 communicates with a managing apparatus in a service center (not shown) by using a network or a public line.

Although not shown, the engine 101 includes a controller including a CPU and a read only memory (ROM). The CPU operates according to a computer program in the ROM, thereby controlling the engine 101.

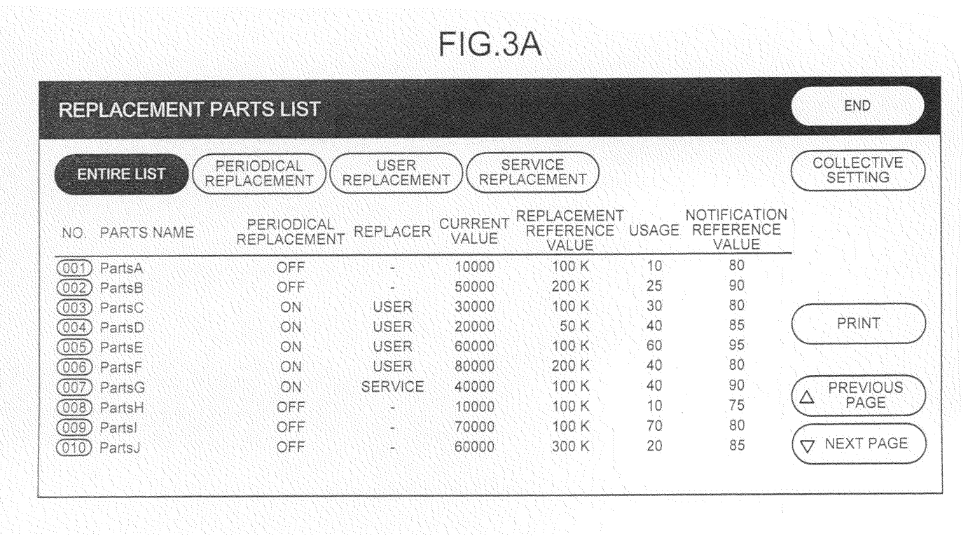

A configuration example of software in the image forming apparatus shown in FIG. 1 is explained with next reference to FIG. 2. The control according to the computer program is practically realized by the CPU that operates according to the computer program. However, for convenience of explanation, it is assumed here that the computer program performs processes.

FIG. 2 is a block diagram of a configuration of software in the image forming apparatus according to the first embodiment.

A setting module 201 is a computer program that performs setting or list display of parts to be replaced (replacement components).

A usage managing module 202 is a computer program that performs update (including detection) of usage of each component, and determination of replacement time of each component to be periodically replaced (hereinafter, “periodical replacement component”).

Setting information 203 kept in the apparatus is stored in the nonvolatile memory 104 as a setting information table.

A reporting module 204 is a computer program that notifies the managing apparatus in the service center of replacement time (end) of a periodically replacement component or that the replacement time is near (near end), or sends an order of a component by utilizing the communicating unit 106 and a network or telephone lines connected to the communicating unit 106.

A measuring module 205 is a computer program that counts usage of each component and notifies the usage managing module 202 of the usage. This computer program is stored in the ROM (not shown) of the engine 101, and used for an operation of the CPU (not shown).

The setting module 201, the usage managing module 202, and the setting information 203 are related the present invention. The reporting module 204 and the measuring module 205 are existing computer programs.

The CPU 105 of the controller 200 operates according to the computer programs above mentioned to control the apparatus including the operating unit 102, thereby realizing functions as a setting unit (including a replacement-time setting unit), an information registering unit (including a usage registering unit, and a replacement-time determining unit), a usage detecting unit, a communication establishing unit, and an information notifying unit.

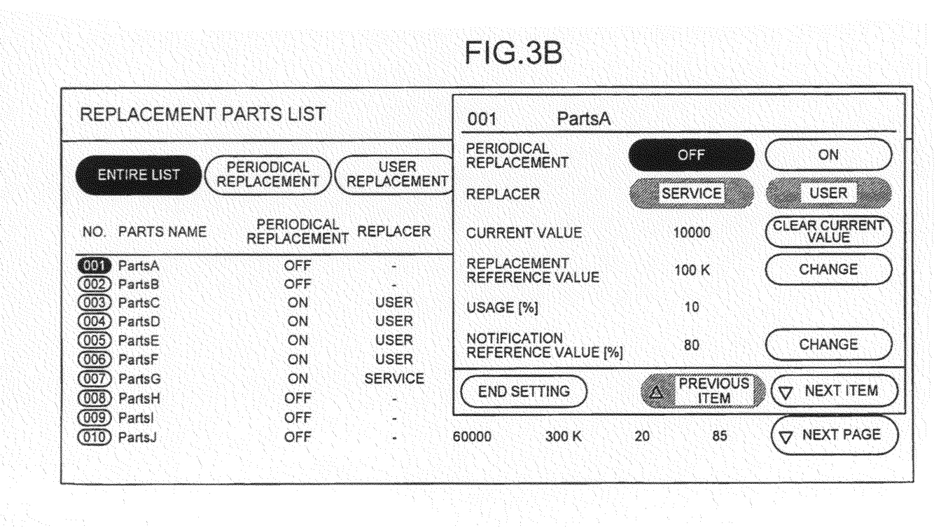

FIGS. 3A to 3C are schematic diagrams of examples of a plurality of operation screens including a replacement-parts list screen (service setting screen) for service engineer displayed on the operating unit 102 in FIG. 1 (practically on a display unit). A selecting or setting operation using the operation screen means an operation on the operation screen when a display includes a touch panel, or an operation using operation keys provided on an input unit when a display does not include a touch panel.

When a topmost component is selected among components (replacement parts) displayed on a replacement-parts list screen as shown in FIG. 3A, a setting screen related to the selected component is displayed as shown in FIG. 3B. The setting screen allows setting as to whether periodical replacement of the selected component is “performed (ON)” or “not performed (OFF)”.

When periodical replacement is set to “ON”, component replacement is performed each time the selected component is used until the component reaches the end of usage (the current value of the component reaches a replacement reference value).

When the periodical replacement is set to “OFF”, the component is replaced at the time of failure of the component, and periodical replacement thereof is not performed.

When the periodical replacement is set to “ON”, a replacer of the component can be set as shown in FIG. 3C.

It is also possible to clear the current value, or change a replacement reference value or a notification reference value (value for notifying a near end).

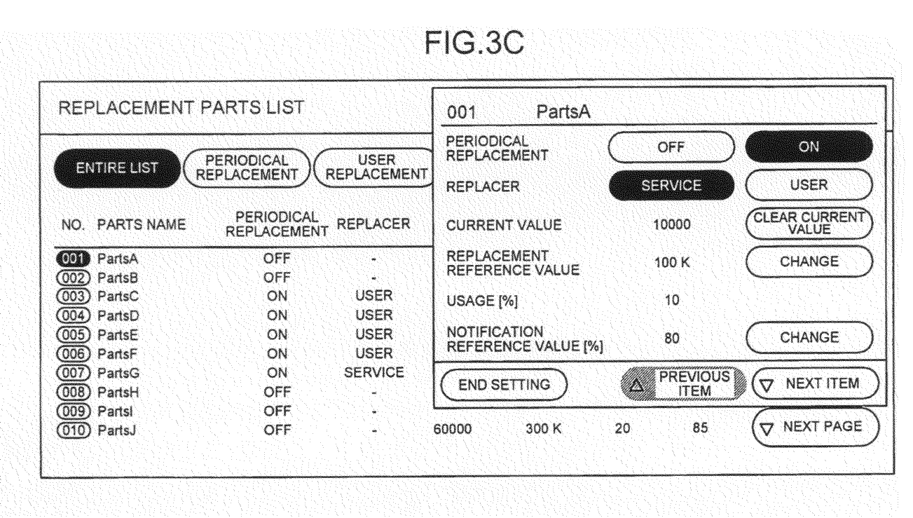

FIG. 4 is the setting information table that is stored as setting information in the apparatus (the nonvolatile memory 104 as shown in FIG. 1) as one example.

This setting information table shows setting information at the end of setting on the setting screen as shown in FIG. 3C.

With respect to a component for which the periodical replacement of which is set to “ON”, “Service” or “User” is set as the replacer. The “Service” means a service engineer of a manufacturer of the apparatus.

With respect to a component the periodical replacement of which is set to “OFF”, setting of the replacer is not performed, and the replacer is undefined (−).

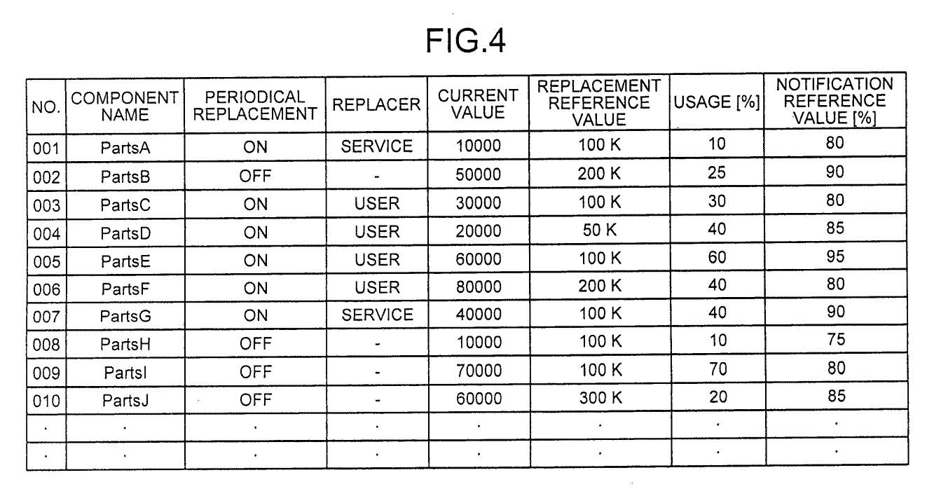

FIG. 5 is a flowchart of an example of a service-setting menu process performed by the CPU 105 shown in FIG. 1.

When a replacement parts menu in a service program is selected by an operation on the operating unit 102, the CPU 105 starts a process routine as shown in FIG. 5. The CPU 105 first checks whether the apparatus is in a service program mode at Step S1.

Operations, such as periodical replacement of components and setting of replacers, are performed by service engineer, and the service engineer can set a service program mode through a predetermined operation on the operating unit 120.

When the apparatus is not in the service program mode, the CPU 105 ends the process. When the apparatus is in the service program mode, the CPU 105 obtains information from the setting information table, and displays a list of the information on a replacement-parts list screen at Step S2. For example, the replacement-parts list screen as shown in FIG. 3A is displayed.

The system control then proceeds to Step S3 to determine a process selected from the replacement-parts list screen.

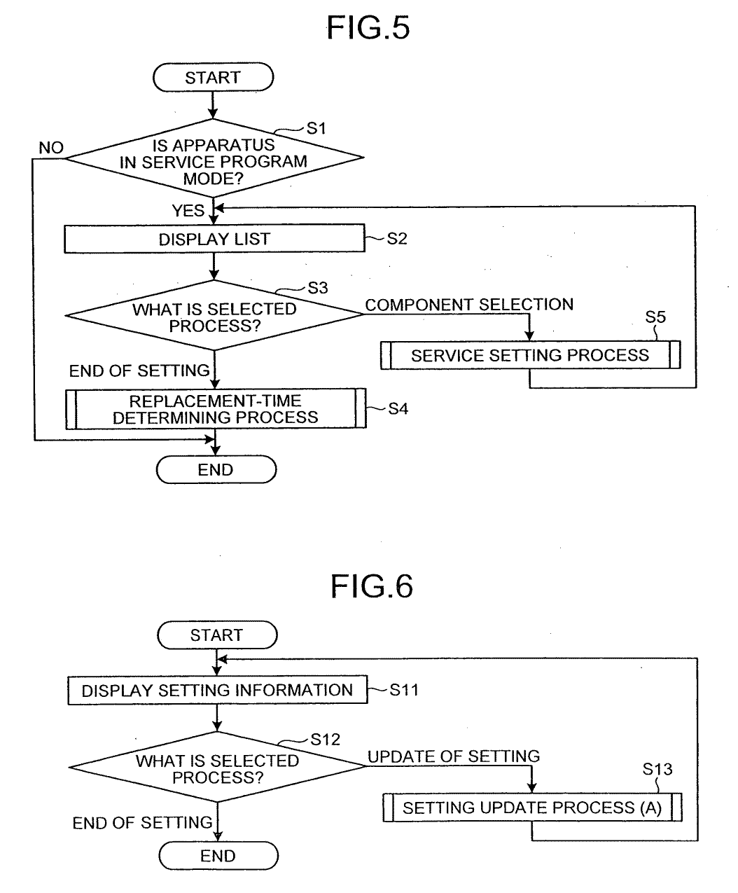

When a result of the determination indicates that the selected process is “component selection”, the CPU 105 performs a service setting process as shown in FIG. 6 at Step S5. Upon completion of the service setting process, the CPU 105 displays a list of information (the replacement-parts list screen) again at Step S2 to reflect updated information. When setting of plural components is performed, the processes at Steps S2, S3, and S5 are repeated.

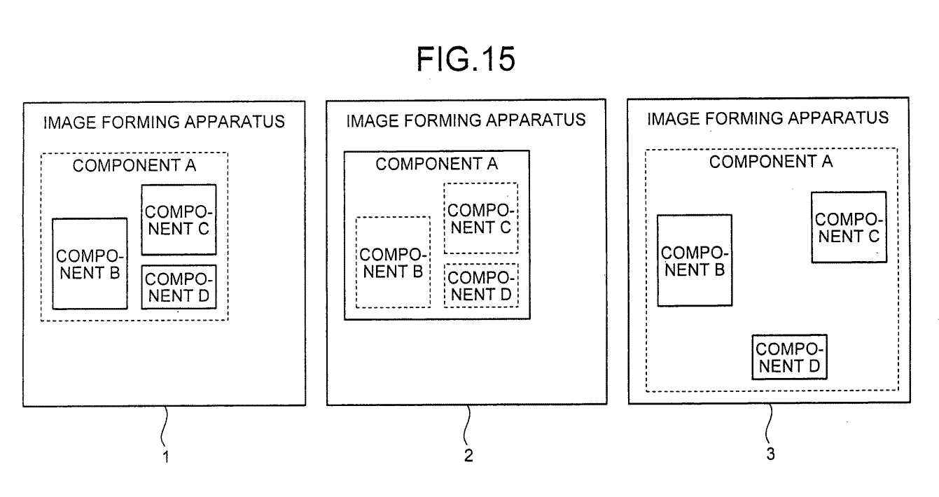

When setting of all components is completed, and “end of setting” is selected, the system control proceeds from Step S3 to Step S4 to perform a replacement-time determining process as shown in FIG. 11, and ends the process.

FIG. 6 is a flowchart of an example of a subroutine of the service setting process at Step S5 in FIG. 5.

When a component is selected in the service-setting menu process as shown in FIG. 5, the CPU 105 starts a process routine as shown in FIG. 6. The CPU 105 first obtains corresponding information from the setting information table, and displays a setting screen indicating current setting information, for example, the setting screen as shown in FIG. 3B at Step S11.

The system control then proceeds to Step S12 and the CPU 105 determines a process selected from the setting screen.

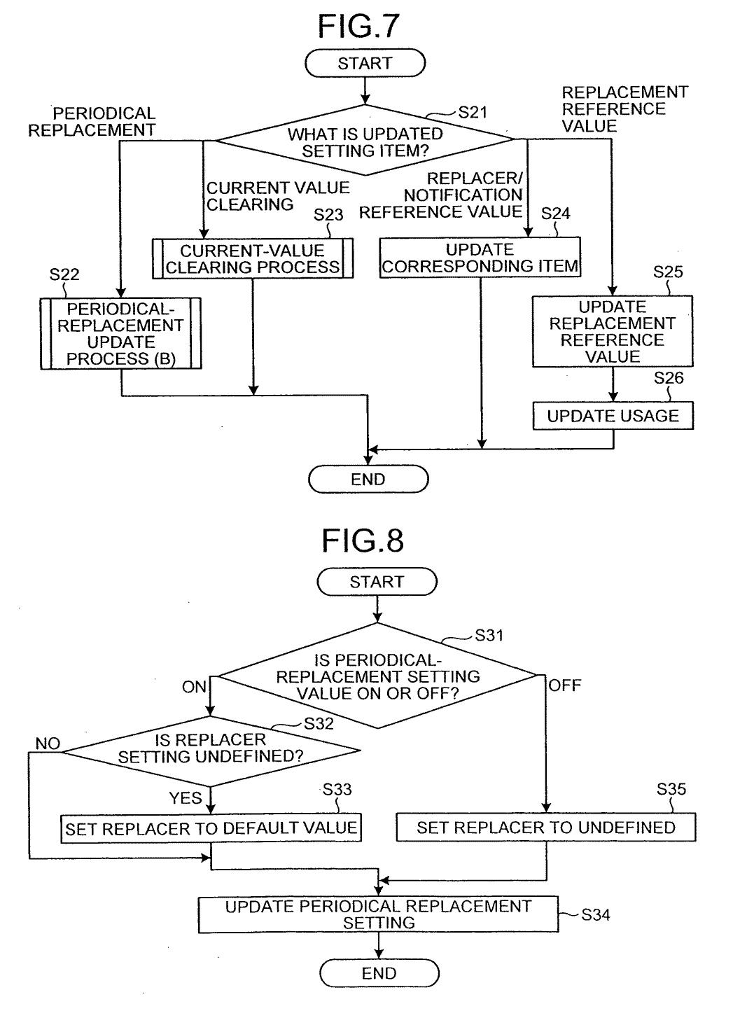

When a result of the determination indicates that the selected process is “update of setting”, the CPU 105 performs a setting update process (A) as shown in FIG. 7 at Step S13. Upon completion of the setting update process, the CPU 105 displays the setting information (setting screen) again at Step S11 to reflect updated information. When setting of a plurality of items is performed, the processes from Step S11 to Step S13 are repeated.

When setting of all items is completed, and then “end of setting” is selected, the CPU 105 ends the process.

FIG. 7 is a flowchart of an example of a subroutine of the setting update process (A) at Step S13 in FIG. 6.

When this process routine starts, the CPU 105 first determines an updated setting item at Step S21.

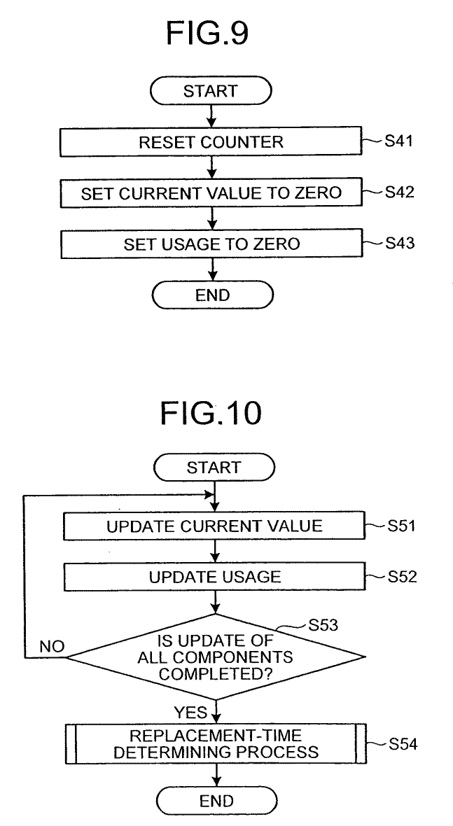

When a result of the determination indicates that the updated setting item is periodical replacement (the periodical replacement is updated), the CPU 105 performs a periodical-replacement update process (B) as shown in FIG. 8 at Step S22.

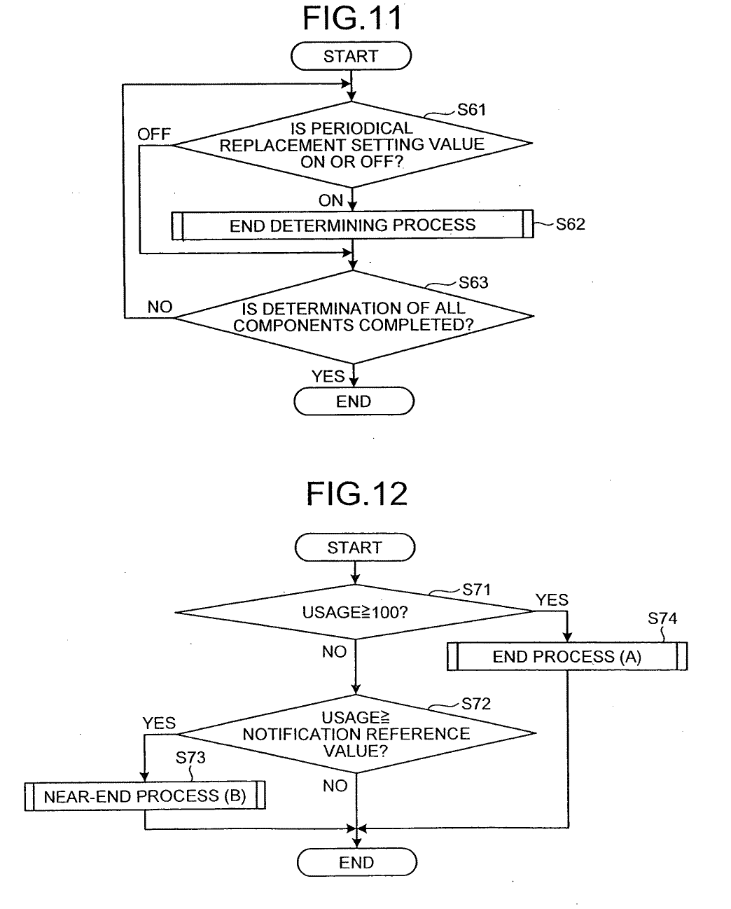

When the updated setting item is current value clearing (when current value clearing is selected), the CPU 105 performs a current-value clearing process as shown in FIG. 9 by issuing an instruction to the usage managing module 202, at Step S23.

When the updated setting item is the replacer or the notification reference value (when the replacer or the notification reference value is updated), the CPU 105 updates the replacer or the notification reference value in the setting information at Step S24.

When the updated setting item is the replacement reference value (when the replacement reference value is updated), the CPU 105 updates the replacement reference value in the setting information at Step S25. The CPU 105 then updates the usage as the usage=the current value/the replacement reference value, at Step S26.

FIG. 8 is a flowchart of an example of a subroutine of the periodical-replacement update process (B) at Step S22 in FIG. 7.

When this process routine starts, the CPU 105 first determines a value to be updated with (periodical-replacement setting value) at Step S31.

When a result of the determination indicates that the periodical-replacement setting value to be updated with is “ON” (when the periodical replacement is to be updated with “ON”), the system control proceeds to Step S32.

At Step S32, the CPU 105 determines whether the replacer is set with reference to the corresponding setting information, and the system control proceeds to Step S33 when the replacer is not set (undefined).

At Step S33, the CPU 105 updates the replacer of the corresponding setting information with a default value (that is, a value set at the factory).

When the periodical-replacement setting value to be updated with is “OFF” (when the periodical replacement is to be updated with “OFF”), the CPU 105 updates the replacer of the corresponding information with undefined (−) at Step S35.

The CPU 105 finally updates the periodical replacement setting in the corresponding setting information at Step S34, and ends the process.

FIG. 9 is a flowchart of an example of a subroutine of the current-value clearing process at Step S23 in FIG. 7.

The current-value clearing process is performed by the usage managing module 202 when current value clearing is performed by the setting module 201.

When a process routine as shown in FIG. 9 starts, the CPU 105 first notifies the engine 101 to cause the engine 101 to reset a counter of the corresponding component at Step S41.

The CPU 105 then sets the current value in the corresponding setting information to “zero” at Step S42.

The CPU 105 then updates the usage in the corresponding setting information to “zero” at Step S43.

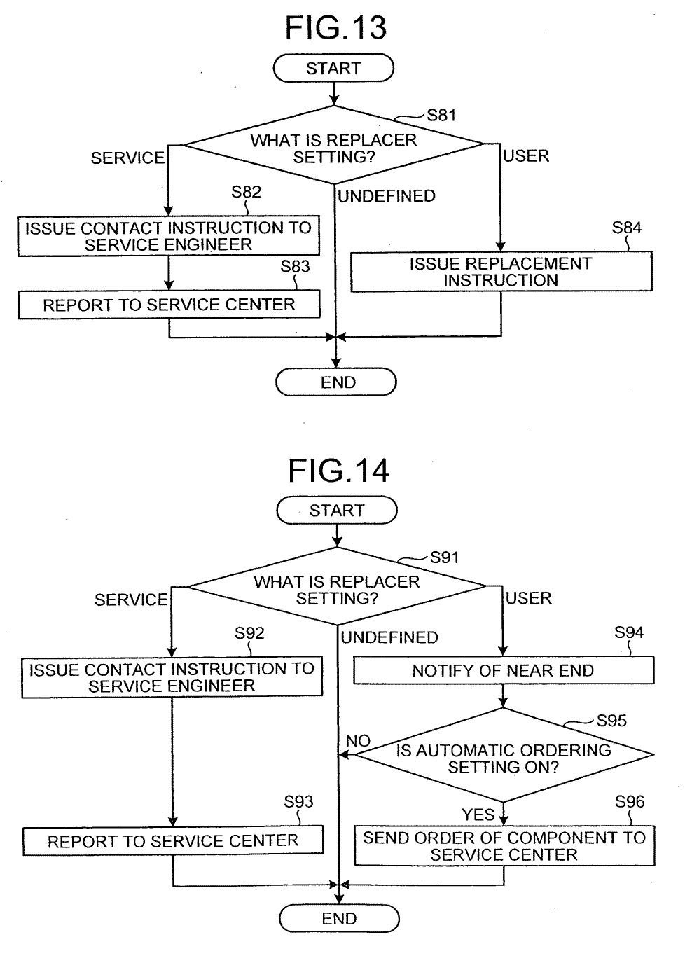

FIG. 10 is a flowchart of an example of a current-value update process (usage update process) performed by the CPU 105 shown in FIG. 1.

The current-value update process is performed by the usage managing module 202 when the CPU 105 is notified of counter information of all components by the engine 101.

When a process routine as shown in FIG. 10 starts, the CPU 105 first updates the current value of the first setting information with a notified value at Step S51.

The CPU 105 then updates the usage in the setting information with “the current value/the replacement reference value” at Step S52.

The CPU 105 then determines whether update processes of all components are completed, at Step S53. When the update processes of all components are not completed, the system control returns to Step S51, and the CPU 105 updates the current value of the next setting information with a notified value and updates the usage in the setting information with “the current value/the replacement reference value” at Step S52. The processes from Step S51 to Step S53 are repeated until update of all the components is completed.

When update of all the components is completed, the system control proceeds to Step S54, and the CPU 105 performs a replacement-time determining process as shown in FIG. 11 and ends the process.

FIG. 11 is a flowchart of an example of a subroutine of the replacement-time determining process at Step S4 in FIG. 5 and at Step S54 in FIG. 10.

The replacement-time determining process is performed by the usage managing module 202 when the current value is updated upon receipt of counter notification from the engine 101, or when setting update is performed by the setting module 201.

When a process routine as shown in FIG. 11 starts, the CPU 105 first determines a periodical-replacement setting value with reference to the first setting information at Step S61.

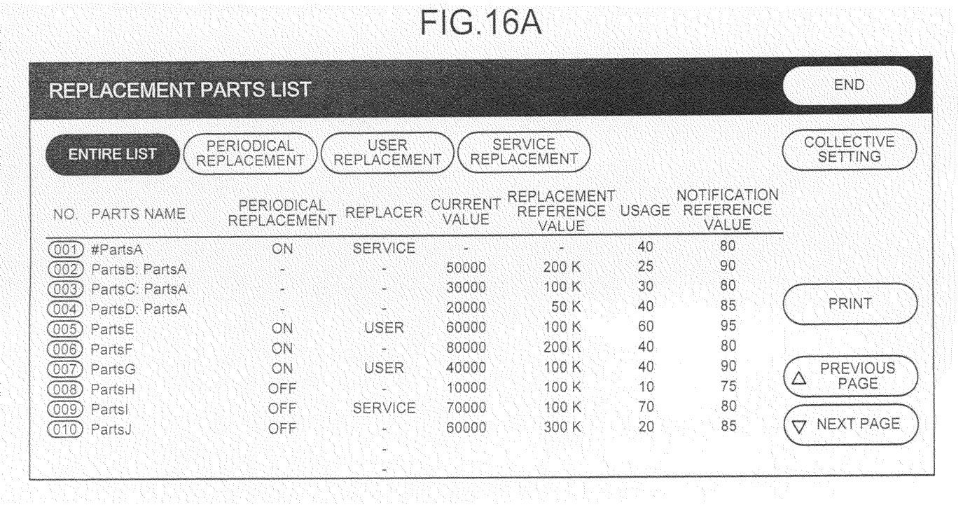

When a result of the determination indicates that the periodical-replacement setting value is “ON” (when the periodical replacement is “ON”), the CPU 105 performs an end determining process as shown in FIG. 12, at Step S62.

When the periodical-replacement setting value is “OFF” (when the periodical replacement is “OFF”) or “undefined”, the CPU 105 does not perform the end determining process because this is not a component to be periodically replaced.

The CPU 105 then determines whether determination of all the components is completed, at Step S63. When the determination of all the components is not completed, the system control returns to Step S61, and the CPU 105 determines a periodical-replacement setting value with reference to the next setting information. When the periodical-replacement setting value is “ON”, the CPU 105 performs the end determining process at Step S62. The processes from Step S61 to Step S63 are then repeated until the determination of all the components is completed.

When the determination of all the components is completed, the process ends.

FIG. 12 is a flowchart of an example of a subroutine of the end determining process at Step S62 in FIG. 11.

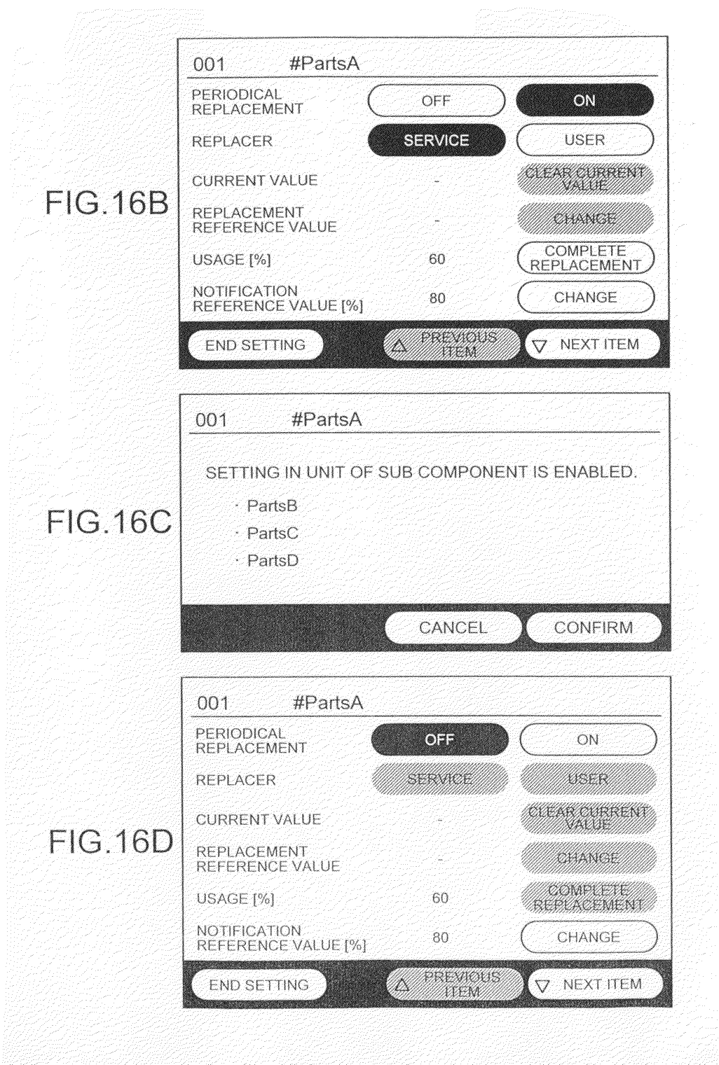

When a process routine as shown in FIG. 12 starts, the CPU 105 first determines whether the usage is equal to or higher than “100” at Step S71. When the usage is equal to or higher than “100”, the CPU 105 performs an end process (A) as shown in FIG. 13, at Step S74.

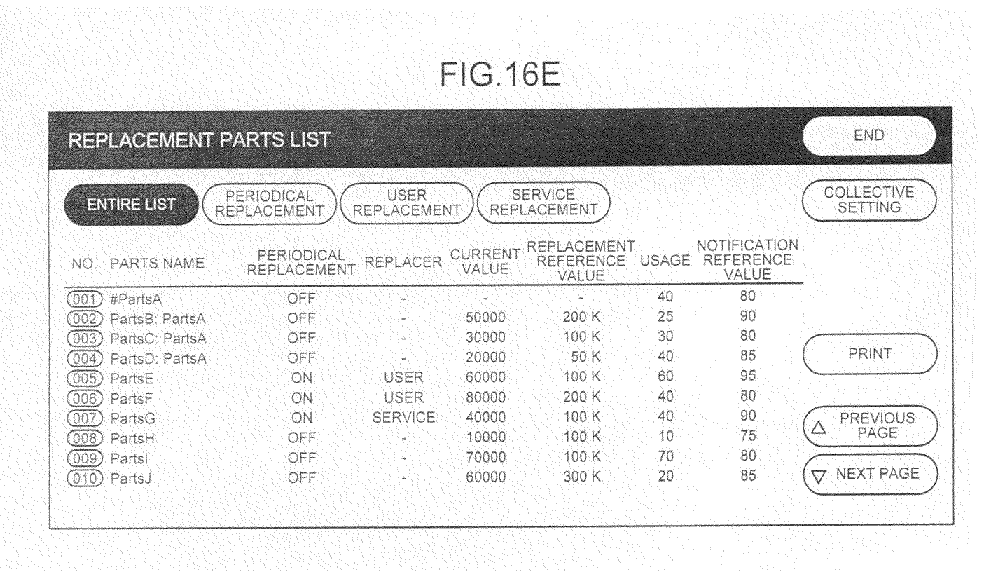

When the usage is lower than “100”, the CPU 105 determines whether the usage is equal to or higher than the notification reference value at Step S72. When the usage is equal to or higher than the notification reference value, the CPU 105 performs a near-end process (B) as shown in FIG. 14 at Step S73. When the usage is lower than the notification reference value, the CPU 105 ends the process.

FIG. 13 is a flowchart of an example of a subroutine of the end process (A) at Step S74 in FIG. 12.

When a process routine as shown in FIG. 13 starts, the CPU 105 first determines a replacer setting value with reference to the corresponding setting information at Step S81.

When a result of the determination indicates that the replacer setting value is “User”, the CPU 105 issues a replacement instruction at Step S84.

When the replacer setting value is “Service engineer”, the CPU 105 issues a contact instruction to service engineer at Step S82, and instructs the reporting module 204 to report to the managing apparatus in the service center at Step S83.

When the replacer setting value is “undefined (−)”, the CPU 105 performs nothing, and ends the process because this is not a component to be periodically replaced.

FIG. 14 is a flowchart of an example of a subroutine of the near-end process (B) at Step S73 in FIG. 12.

When a process routine as shown in FIG. 14 starts, the CPU 105 first determines a replacer setting value with reference to the corresponding setting information at Step S91.

When a result of the determination indicates that the replacer setting value is “User”, the CPU 105 issues notification of a near end at Step S94.

The CPU 105 then determines whether automatic ordering setting is ON or OFF at Step S95. When the automatic ordering setting is ON, the CPU 105 instructs the reporting module 204 to send an order of the component to the managing apparatus in the service center at Step S96.

When the replacer setting value is “Service engineer”, the CPU 105 issues a contact instruction to service engineer at Step S92, and instructs the reporting module 204 to report to the managing apparatus in the service center at Step S93.

When the replacer setting value is “undefined (−)”, the CPU 105 performs nothing and ends the process because this is not a component to be periodically replaced.

An image forming apparatus according to a second embodiment of the present invention is explained next. Hardware and software configurations thereof are the same as those described with reference to FIGS. 1 and 2, and therefore explanations thereof will be omitted.

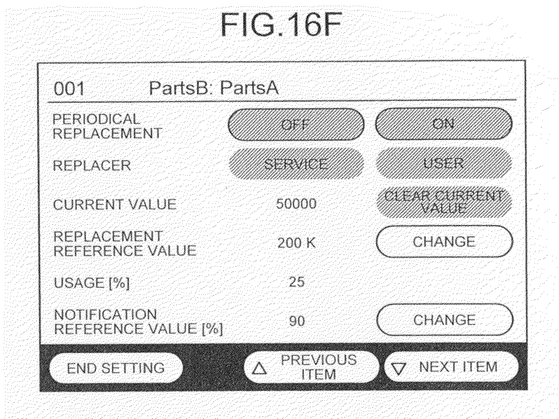

FIG. 15 is a schematic diagram of examples of relations of main and sub components. The examples assume three image forming apparatuses each having the configuration as shown in FIG. 1.

The relations of main and sub components include one in which sub components are physically included in a main component as shown by image forming apparatuses 1 and 2, and one in which components are handled functionally as main and sub components as shown by an image forming apparatus 3.

The image forming apparatus 1 indicates an example in which setting is performed with respect to each sub component, and components B, C, and D are individually managed in their usages and replaced.

An example of the main component (component A) is a process cartridge unit (PCU). The PCU is a unit including a photosensitive element on which an electrostatic latent image is formed, a charging roller that charges the surface of the photosensitive element, a developing unit that develops the latent image formed on the photosensitive element with toner to form a toner image, a cleaning unit that cleans toner remaining on the photosensitive element after transfer, and the like.

The sub components (such as the components B and C) include a cleaning blade and a coating bar (bar of zinc stearate as a coated film member that provides lubricity to the front surface of a photosensitive element).

The image forming apparatus 2 includes a main component (for example, a PCU) including a plurality of sub components. The image forming apparatus 2 is an example in which setting is performed with respect to a main component A. Replacement is performed with respect to the main component (unit) as a group including the components B, C, and D. Usage of the main component is set to usage of a sub component that has been most used (that is nearest to the end of lifetime). When any of the sub components reaches to the replacement time, these components are replaced.

The image forming apparatus 3 is an example in which a plurality of sub components that is not physically included in a component is handled functionally as a group (main component). An example of the functional main component is a photosensitive element. Examples of the sub component are a developing unit and a developing material. Replacement of the components of the image forming apparatus 3 is practically performed with respect to each sub component. When it is intended in the operation that the usages of the components should be managed in a lump and the components be replaced simultaneously, such components are handled as those in the image forming apparatus 3. Management of the usages is performed like in the image forming apparatus 2.

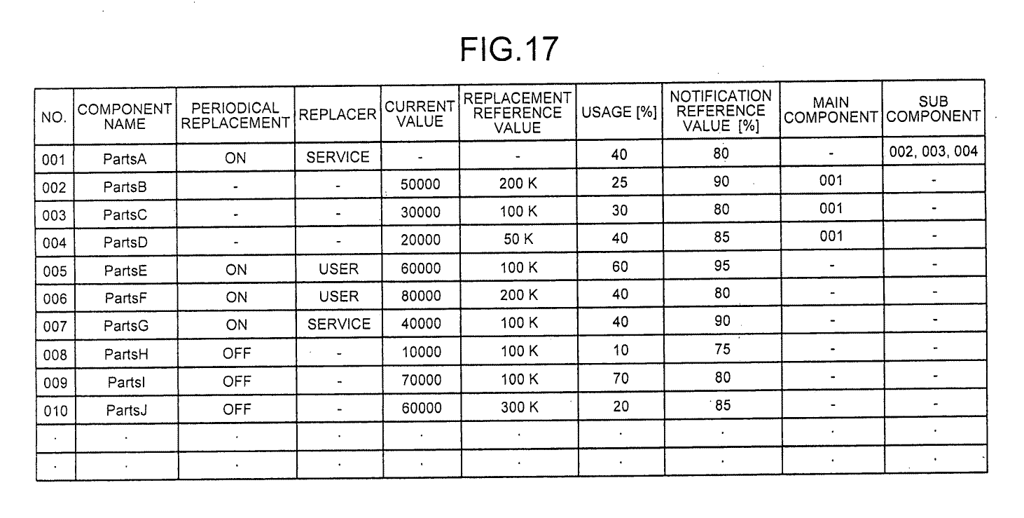

FIGS. 16A to 16F are schematic diagrams of examples of a plurality of operation screens including a replacement-parts list screen for service engineer in consideration of the main and sub components displayed on the operating unit 102 shown in FIG. 1.

On the replacement-parts list screen as shown in FIG. 16A, “#” is prefixed to the name of the main component. With respect to the sub components, “: main component name” is postfixed to the name.

When the main component “PartsA” is selected among the components displayed on the replacement-parts list screen, a setting screen related to the selected main component is displayed as shown in FIG. 16B.

The main component does not have a counter for the main component, and therefore the current value and a replacement reference value are undefined (−). It is also impossible to clear the current value and change the replacement reference value. When the main component is replaced, the usage is rest by pressing “complete replacement”. When “complete replacement” is selected, current values of all sub components in the main component are cleared. The button of “complete replacement” is selectable only for components that are main components and the periodical replacement of which is set to “ON”.

When the periodical replacement of the main component is updated with “OFF”, a confirmation screen as shown in FIG. 16C is displayed. When “confirm” is selected, the setting is updated as shown in FIG. 16D. Because the periodical-replacement setting value is updated with “OFF”, the replacer becomes undefined and “complete replacement” is invalidated. When “end setting” is selected, the screen returns to a replacement-parts list screen as shown in FIG. 16E.

When a sub component “PartsB” is selected from the replacement-parts list screen as shown in FIG. 16A, a setting screen related to the sub component is displayed as shown in FIG. 16F. In this case, setting with respect to each sub component cannot be performed because the periodical replacement of the main component “PartsA” is set to “ON”. Therefore, the periodical replacement and the replacer are both undefined (−).

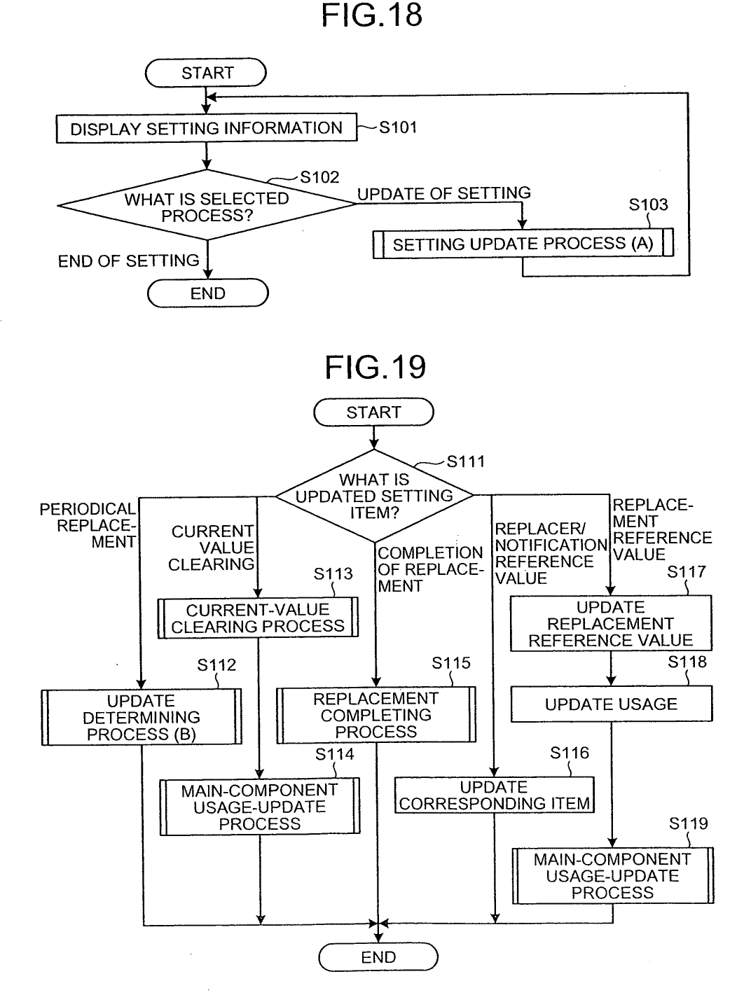

FIG. 17 is the setting information table in consideration of the relation between the main and sub components, stored in the apparatus as setting information as one example.

This setting information table shows setting information at the time when the replacement-parts list screen as shown in FIG. 16A is displayed. The relation of “PartsA” to “PartsD” corresponds to the main and sub relation of the image forming apparatus 2 as shown in FIG. 15.

When the periodical replacement of the main component “PartsA” is set to “ON”, the periodical replacement and the replacers of the sub components “PartsB”, “PartsC”, and “PartsD” are undefined (−). The current value and the replacement reference value of the main component “PartsA” are undefined (−) because the main component does not have a counter for the main component.

The usage of the main component “PartsA” is set at 40%, which is the maximum usage among those of the sub components “PartsB (25%)”, “PartsC (30%)”, and “PartsD (40%)”.

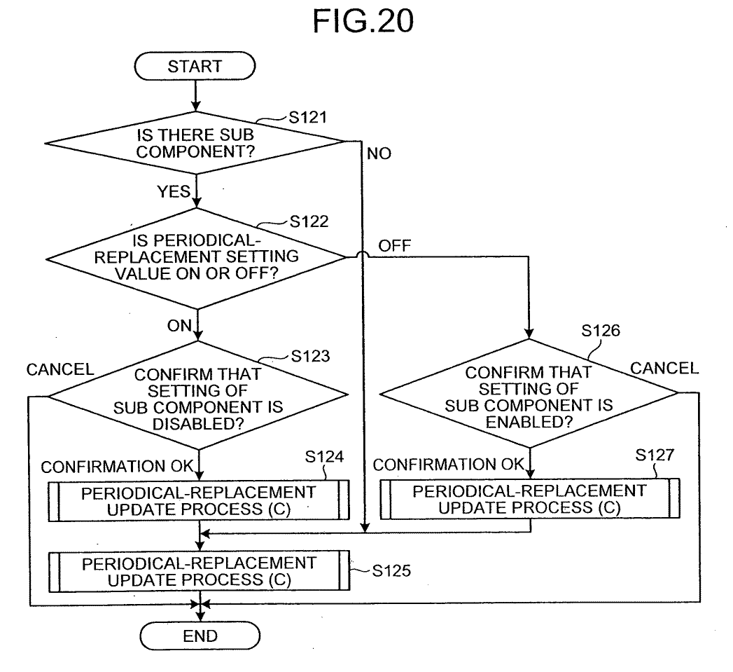

FIG. 18 is a flowchart of another example of the subroutine of the service setting process shown in FIG. 5.

When a component is selected in the service-setting menu process as shown in FIG. 5, the CPU 105 starts a process routine as shown in FIG. 18. The CPU 105 first obtains corresponding information from the setting information table to display a setting screen indicating current setting information, for example, the setting screen as shown in FIG. 16B or 16F, at Step S101.

The system control then proceeds to Step S102 and the CPU 105 determines a process selected on the setting screen.

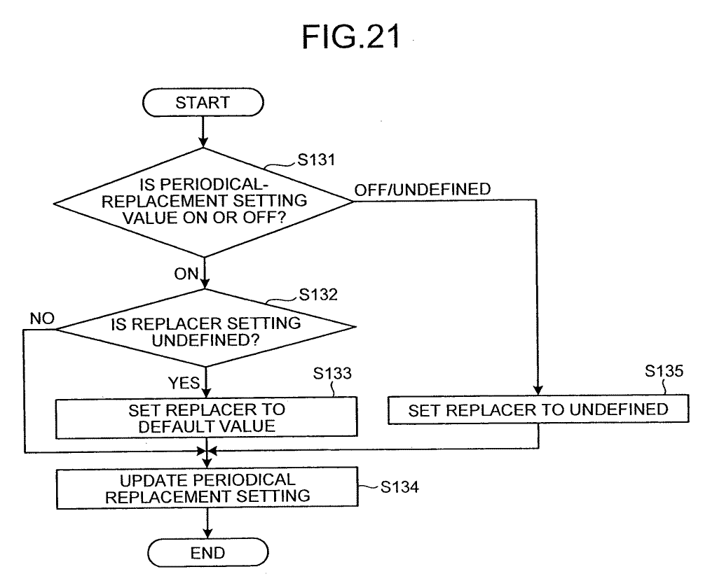

When a result of the determination indicates that the selected process is “update of setting”, the CPU 105 performs a setting update process (A) as shown in FIG. 19 at Step S103. Upon completion of the setting update process, the setting information (setting screen) is displayed again at Step S101 to reflect updated information. When setting of a plurality of items is to be performed, the processes from Step S101 to Step S103 are repeated.

When setting all the items is completed, and then “end of setting” is selected, the CPU 105 ends the process.

FIG. 19 is a flowchart of an example of a subroutine of the setting update process (A) at Step S103 in FIG. 18.

When this process routine starts, the CPU 105 first determines an updated setting item at Step S111.

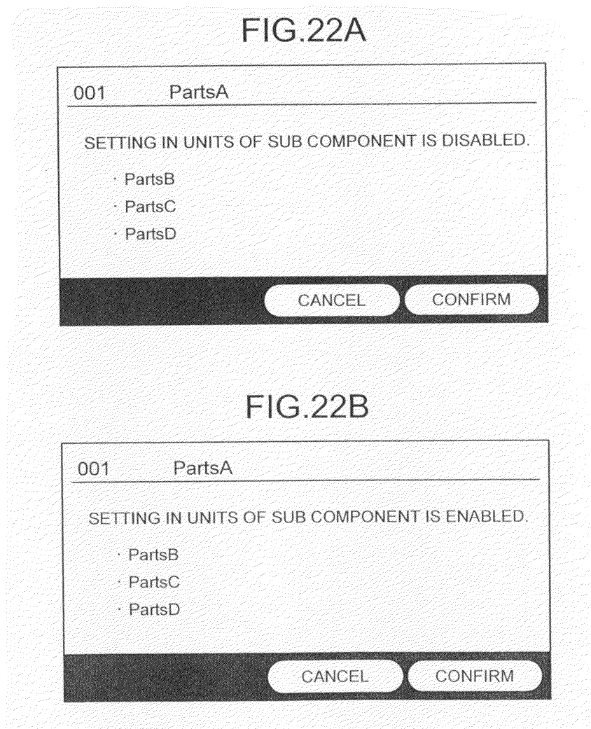

When a result of the determination indicates that the updated setting item is periodical replacement (when the periodical replacement is updated), the CPU 105 performs an update determining process (B) as shown in FIG. 20 at Step S112.

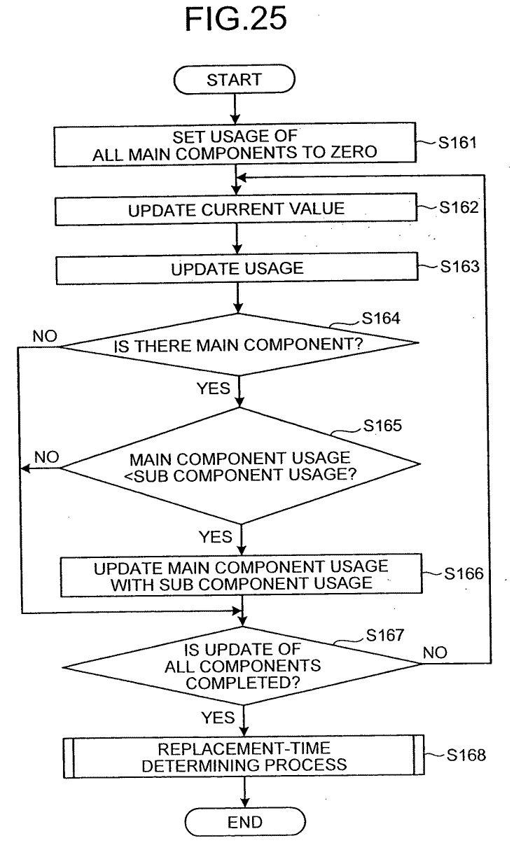

When the update setting item is current value clearing (when current value clearing is selected), the CPU 105 performs the current-value clearing process as shown in FIG. 9 by issuing an instruction to the usage managing module 202, at Step S113. The CPU 105 then performs a main-component usage-update process as shown in FIG. 23 by issuing an instruction to the usage managing module 202, at Step S114.

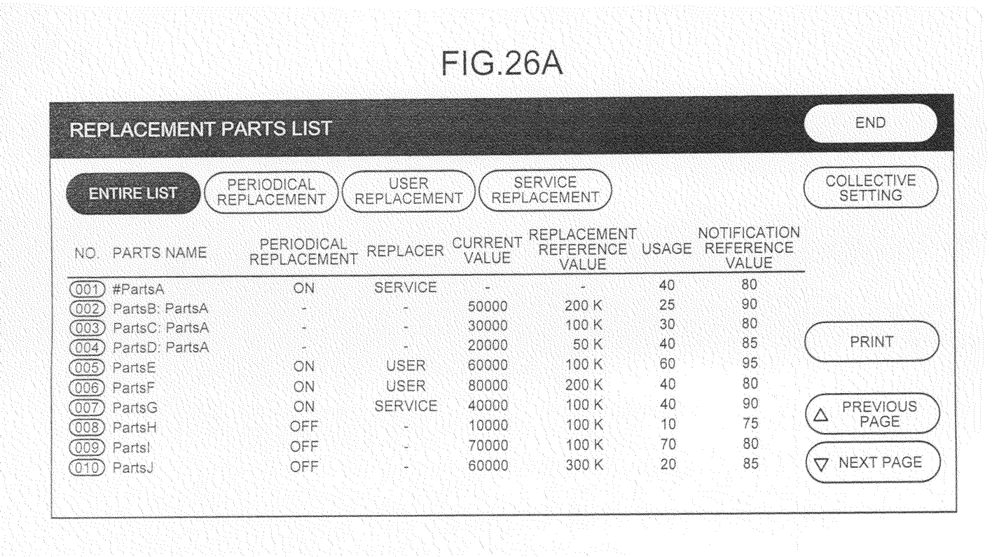

When the updated setting item is completion of replacement (when completion of replacement is selected), the CPU 105 performs a replacement completing process as shown in FIG. 24 by issuing an instruction to the usage managing module 202, at Step S115.

When the updated setting item is the replacer or the notification reference value (when the replacer or the notification reference value is updated), the CPU 105 updates the replacer or the notification reference value in the setting information at Step S116.

When the update setting item is the replacement reference value (when the replacement reference value is updated), the CPU 105 updates the replacement reference value in the setting information at Step S117, and updates the usage with the current value/the replacement reference value at Step S118. The CPU 105 then performs the main-component usage-update process as shown in FIG. 23 by issuing an instruction to the usage managing module 202, at Step S119.

FIG. 20 is a flowchart of an example of a subroutine of the update determining process (B) at Step S112 in FIG. 19.

The update determining process (B) is a process for determining whether to perform update of periodical replacement setting.

When a process routine as shown in FIG. 20 starts, the CPU 105 first refers to the corresponding setting information to determine whether a component to be updated (hereinafter, “update target component”) has a sub component, at Step S121.

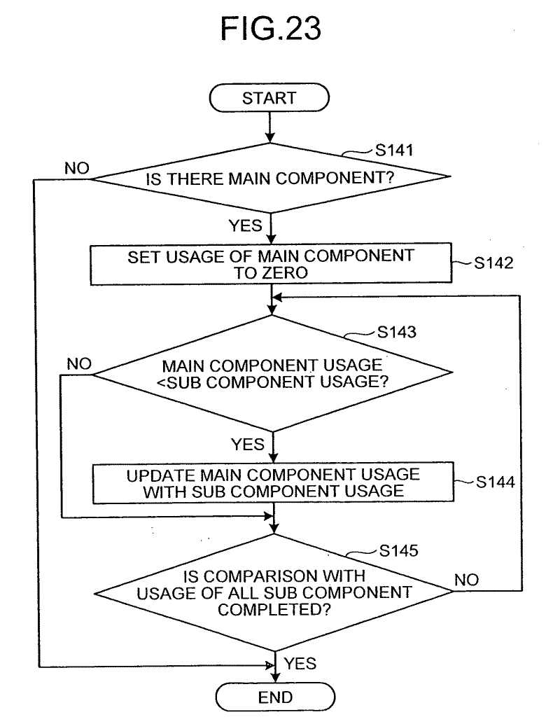

When a result of the determination indicates that the update target component has no sub component, the CPU 105 performs a periodical-replacement update process (C) as shown in FIG. 21, at Step S125.

When the update target component includes sub components, the CPU 105 determines an update value of the periodical replacement setting (periodical-replacement setting value) at Step S122.

When a result of the determination indicates that the update value of the periodical replacement setting is “ON” (when the periodical replacement is updated with “ON”), the CPU 105 confirms that setting with respect to each sub component is disabled, at Step S123.

When the update is canceled as a result of the confirmation, the CPU 105 ends the process. When OK is selected, the CPU 105 performs the periodical-replacement update process (C) for all sub components in the update target component, thereby updating the setting values with undefined (−), at Step S124.

When a result of the determination indicates that the update value of the periodical replacement setting is “OFF” (when the periodical replacement is updated with “OFF”) at Step S122, the CPU 105 confirms that setting with respect to each sub component is enabled, at Step S126.

When the update is canceled as a result of the confirmation, the CPU 105 ends the process. When OK is selected, the CPU 105 performs the periodical-replacement update process (C) for all sub components in the update target component, thereby updating the setting values with default values (values set at the factory), at Step S127.

After updating the setting of the sub components at Step S124 or Step S127, the CPU 105 performs the periodical-replacement update process (C) for the update target component (main component) at Step S125, and ends the process.

FIG. 21 is a flowchart of an example of a subroutine of the periodical-replacement update process (C) at Step S125 in FIG. 20.

When this process routine starts, the CPU 105 first determines a value to be updated with (periodical-replacement setting value) at Step S131.

When a result of the determination indicates that the periodical-replacement setting value to be updated with is “ON” (when the periodical replacement is updated with “ON”), the system control proceeds to Step S132.

The CPU 105 then determines whether the replacer is set with reference to the corresponding setting information at Step S132. When the replacer is not set (when the replacer is undefined), the system control proceeds to Step S133.

The CPU 105 then updates the replacer in the corresponding setting information with a default value (=value set at the factory) at Step S133.

When the periodical-replacement setting value to be updated with is “OFF” (when the periodical replacement is to be updated with “OFF”), the CPU 105 updates the replacer in the corresponding setting information with “undefined (−)” at Step S135.

The CPU 105 finally updates the periodical replacement setting of the corresponding setting information at Step S134, and ends the process.

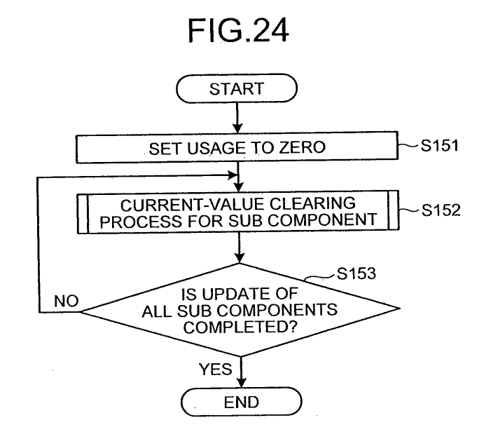

FIGS. 22A and 22B are schematic diagrams of examples of notification displayed when periodical replacement setting of a main component is changed.

FIG. 22A is a schematic diagram of an example of a confirmation screen displayed when periodical replacement setting of a main component is updated with “ON”. This confirmation screen is displayed for the confirmation at Step S123 in FIG. 20.

FIG. 22B is a schematic diagram of an example of a confirmation screen displayed when periodical replacement setting of a main component is updated with “OFF”. This confirmation screen is displayed for the confirmation at Step S126 in FIG. 20.

FIG. 23 is a flowchart of an example of a subroutine of the main-component usage-update process at Steps S114 and S119 in FIG. 19.

The main-component usage-update process is performed by the usage managing module 202. When the current value of a component is cleared or a replacement reference value thereof is changed and then the usage is updated, it is determined whether this component has a main component, and, when it has a main component, usage of the main component is updated.

When a process routine as shown in FIG. 23 starts, the CPU 105 first determines whether there is a main component at Step S141.

When a result of the determination indicates that there is no main component, the CPU 105 ends the process.

When there is a main component, the CPU 105 sets the usage of the main component to zero at Step S142.

The CPU 105 then checks whether usage of a sub component is larger than the usage of the main component, at Step S143. When the usage of the sub component is larger, the CPU 105 updates the usage of the main component with the usage of the sub component, at Step S144.

The CPU 105 then determines whether comparison of usage between the main component and all sub components is completed, at Step S145. When the comparison is not completed yet, the system control returns to Step S143 and the CPU 105 checks whether usage of a remaining sub component is larger than the usage of the main component. When the usage of the remaining sub component is larger, the CPU 105 updates the usage of the main component with the usage of the sub component (writes the usage of the sub component over the usage of the main component) at Step S144. The processes from Step S143 to Step S145 are repeated until the comparison of usage between the main component and all the sub components is completed.

Upon completion of the comparison of the usage between the main component and all the sub components, the CPU 105 ends the process.

When the current value of the sub component PartsD is cleared in the setting example shown in FIG. 17, the CPU 105 first sets the usage of the main component “PartsA” at “zero”, and then compares the usages between the main component and the sub components “PartsB”, “PartsC”, and “PartsD”. When the usage of any of the sub components is larger than the usage of the main component, the largest one of the usages of the sub components, that is, the usage of the sub component “PartsC” is written over the usage of the main component. Accordingly, the usage of the main component “PartsA” is set at “30”.

FIG. 24 is a flowchart of an example of a subroutine of the replacement completing process at Step S115 in FIG. 19.

The replacement completing process is performed by the usage managing module 202 when the replacement of components is performed with respect to each main component.

When a process routine as shown in FIG. 24 starts, the CPU 105 first sets the usage of an update target component (main component) to “zero” at Step S151.

The CPU 105 then performs the current-value clearing process (FIG. 9) for the sub component at Step S152.

The CPU 105 then determines whether the current-value clearing process for all the sub components is completed, at Step S153. When the current-value clearing process for all the sub components is not completed yet, the system control returns to Step S152 and the CPU 105 performs the current-value clearing process for the remaining sub component. The processes at Steps S152 and S153 are repeated until the current-value clearing process for all the sub components is completed.

Upon completion of the current-value clearing process for all the sub components, the CPU 105 ends the process.

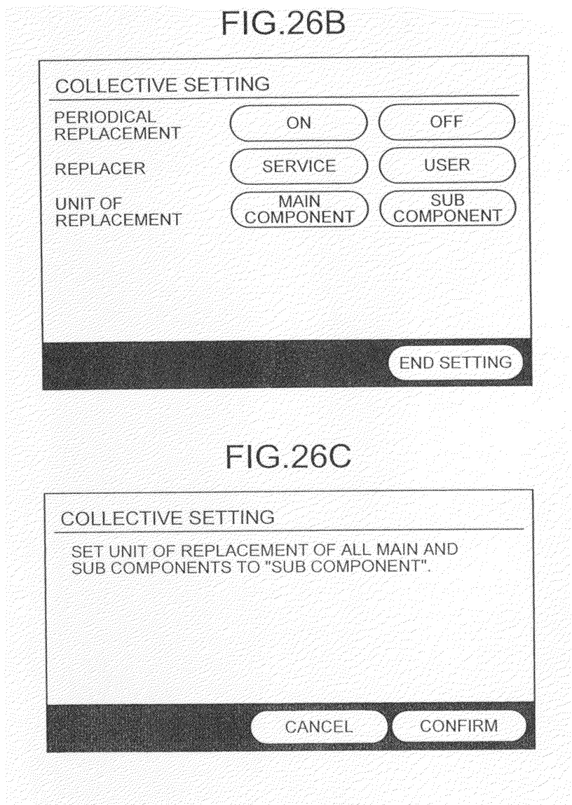

FIG. 25 is a flowchart of another example of the current-value update process performed by the CPU 105 shown in FIG. 1.

The current-value update process is performed by the usage managing module 202 when counter information of all components is notified from the engine 101.

When a process routine as shown in FIG. 25 starts, the CPU 105 first sets the usages of all the main components to “zero” at Step S161.

The CPU 105 then updates the current value in the top setting information with a notified value at Step S162, and updates the usage in the setting information with “the current value/the replacement reference value” at Step S163.

The CPU 105 then checks whether the update target component has a main component with reference to the setting information at Step S164. When there is no main component, the system control proceeds to Step S167. When there is a main component, the CPU 105 compares the usages between the update target component (sub component) and the main component at Step S165. When the usage of the update target component does not exceed the usage of the main component, the system control proceeds to Step S167. When the usage of the update target component exceeds the usage of the main component, the CPU 105 updates the usage of the main component with the usage of the sub component at Step S166.

The CPU 105 then determines whether the update process for all the components is completed, at Step S167. When the update process for all the components is not completed yet, the system control returns to Step S162 and the CPU 105 updates the current value in the next setting information with a notified value. The CPU 105 then repeatedly performs the processes as described above (from Step S162 to Step S167).

When the update process for all the components is completed, the system control proceeds to Step S168, and the CPU 105 performs the replacement-time determining process as shown in FIG. 11 and then ends the process.

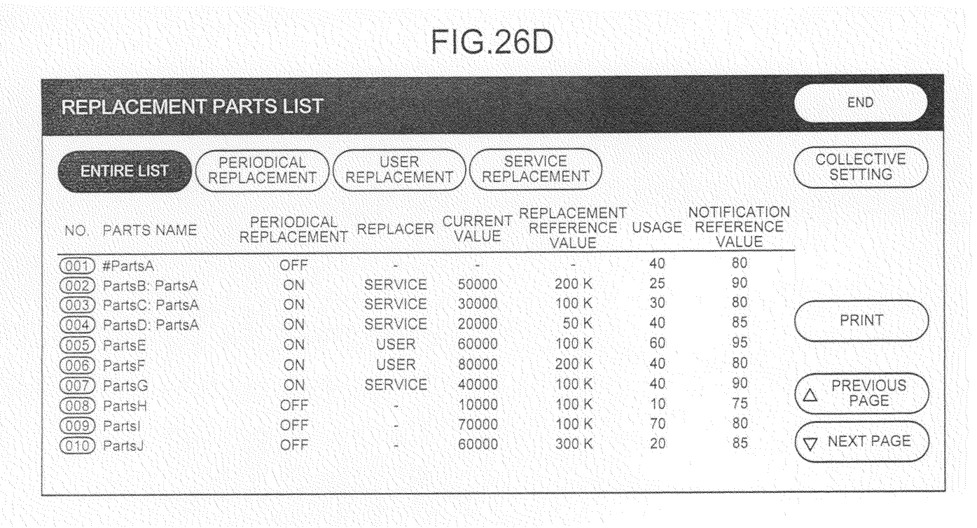

FIGS. 26A to 26D are schematic diagrams of examples of a plurality of operation screens including a replacement-parts list screen and a collective setting screen for service engineer in consideration of the main and sub components displayed on the operating unit 102 shown in FIG. 1.

When “collective setting” is selected on the replacement-parts list screen as shown in FIG. 26A, the collective setting screen as shown in FIG. 26B is displayed.

The collective setting screen allows collective setting of the periodical replacement, the replacers, and the units of replacement of all components.

When a “sub component” is selected as a unit of replacement, an execution confirmation screen as shown in FIG. 26C is displayed. When “confirm” is selected, the collective setting is performed, and then the screen returns to a replacement-parts list screen as shown in FIG. 26D.

The collective setting updates the periodical replacement setting of the main component “PartsA” with “OFF”, and updates the periodical replacement setting of the sub components “PartsB”, “PartsC”, and “PartsD” of the main component “PartsA” with “ON”.

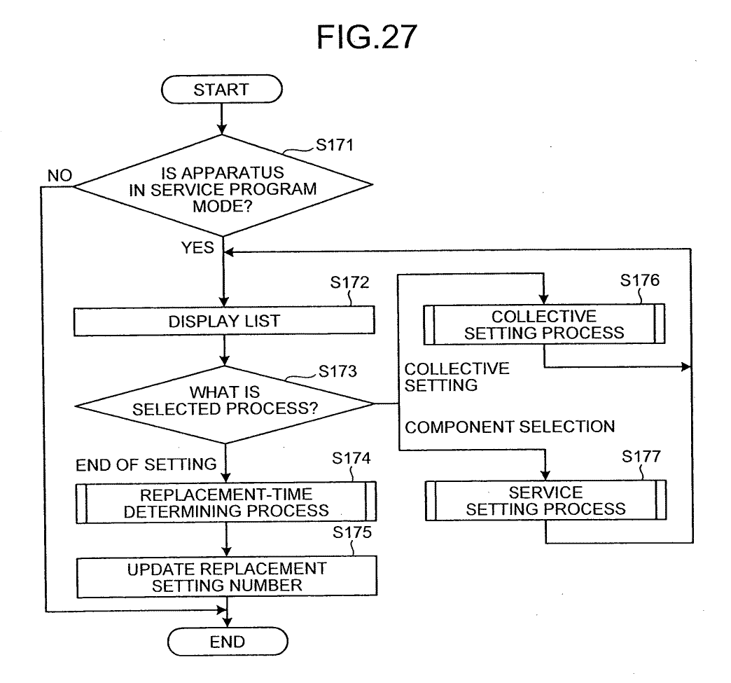

FIG. 27 is a flowchart of an example of the service-setting menu process in consideration of the collective setting performed by the CPU 105 shown in FIG. 1.

When a replacement parts menu of a service program is selected by an operation through the operating unit 102, the CPU 105 starts the process routine as shown in FIG. 20, and first checks whether the apparatus is in a service program mode, at Step S171.

When the apparatus is not in a service program mode, the CPU 105 ends the process. When the apparatus is in a service program mode, the CPU 105 obtains information from the setting information table and displays a list of the information as a replacement-parts list screen, at Step S172. For example, the replacement-parts list screen as shown in FIG. 26A is displayed.

The system control then proceeds to Step S173 and the CPU 105 determines a process selected on the replacement-parts list screen.

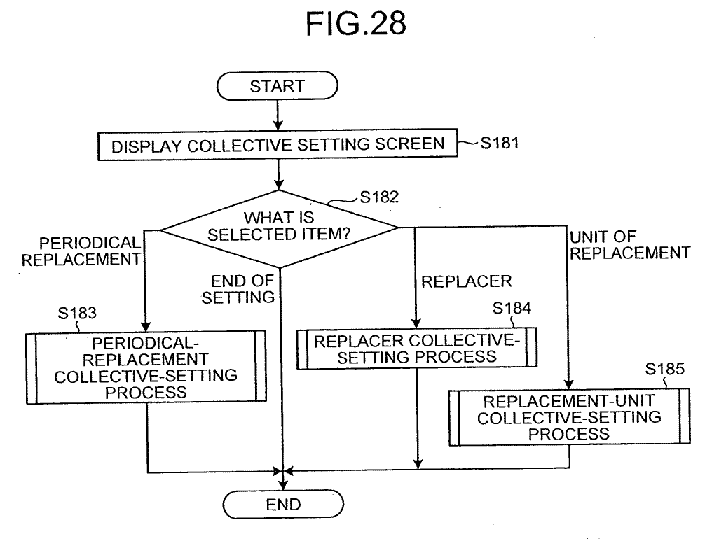

When a result of the determination indicates that the selected process is “collective setting”, the CPU 105 performs a collective setting process as shown in FIG. 28, at Step S176.

When the selected process is “component selection”, the CPU 105 performs the service setting process as shown in FIG. 18, at Step S177.

Upon completion of the collective setting process at Step S176 or the service setting process at Step S177, the CPU 105 displays again a list of information (the replacement-parts list screen) to reflect updated information, at Step S172.

When setting of all the components is completed, and “end of setting” is selected, the CPU 105 performs the replacement-time determining process as shown in FIG. 11, at Step S174. The CPU 105 then updates a replacement setting number at Step S175, and ends the process.

FIG. 28 is a flowchart of an example of a subroutine of the collective setting process at Step S176 in FIG. 27.

When collective setting is selected in the service-setting menu process as shown in FIG. 27, the CPU 105 starts the process routine as shown in FIG. 28, and first displays the collective setting screen as shown in FIG. 26B at Step S181.

The system control then proceeds to Step S182 and the CPU 105 determines an item selected on the collective setting screen.

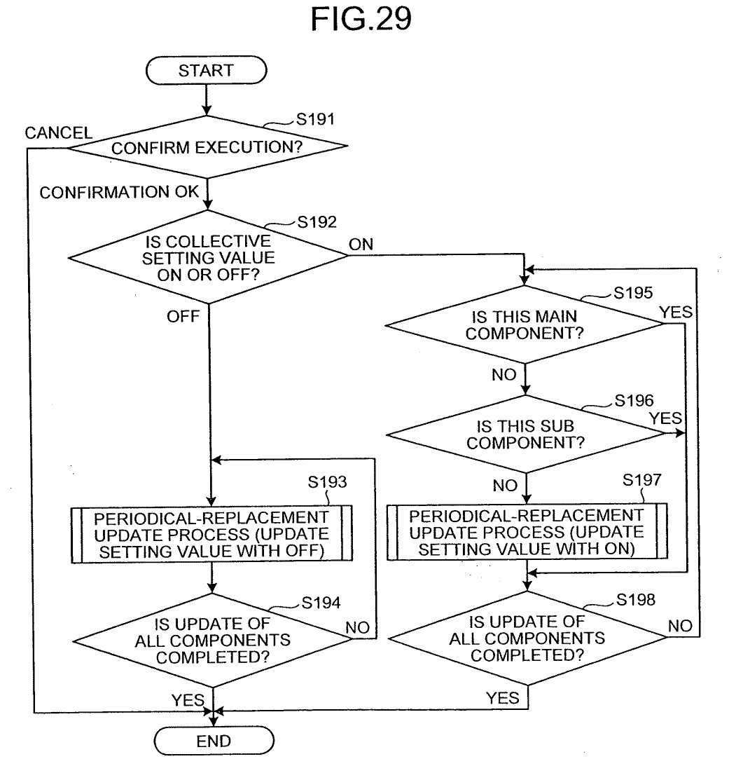

When a result of the determination indicates that the selected item is “ON” or “OFF” of the “periodical replacement”, the CPU 105 performs a periodical-replacement collective-setting process as shown in FIG. 29, at Step S183.

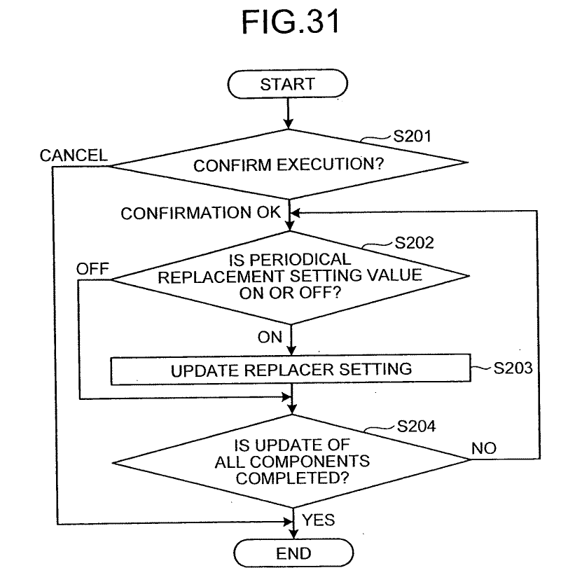

When the selected item is “service” or “user” of the “replacer”, the CPU 105 performs a replacer collective-setting process as shown in FIG. 31, at Step S184.

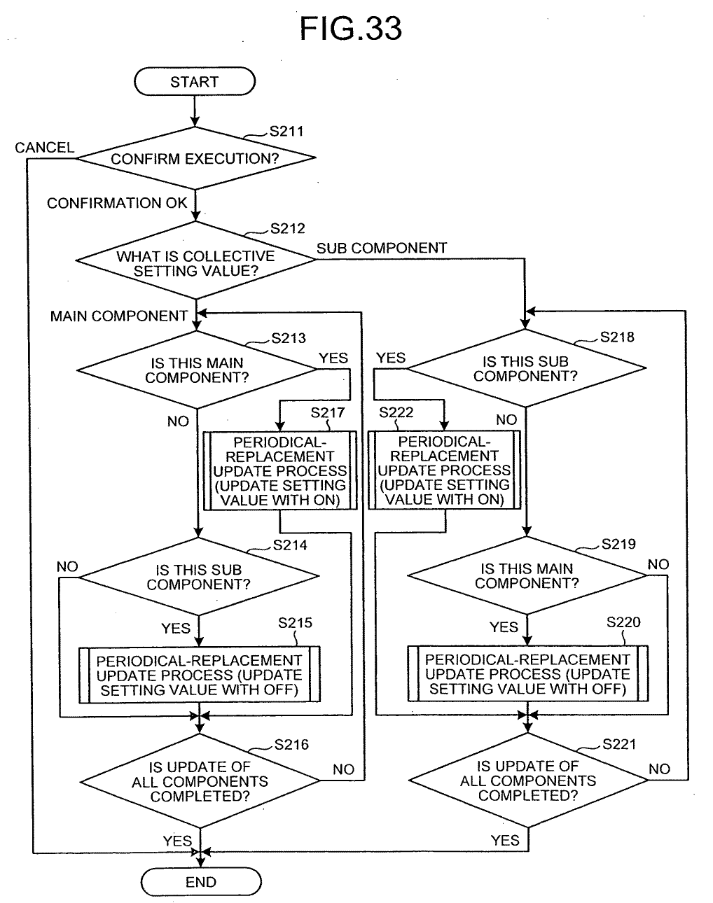

When the selected item is “main component” or “sub component” of the “unit of replacement”, the CPU 105 performs a replacement-unit collective-setting process as shown in FIG. 33, at Step S185.

When the selected item is “end of setting”, the CPU 105 ends the process.

FIG. 29 is a flowchart of an example of a subroutine of the periodical-replacement collective-setting process at Step S183 in FIG. 28.

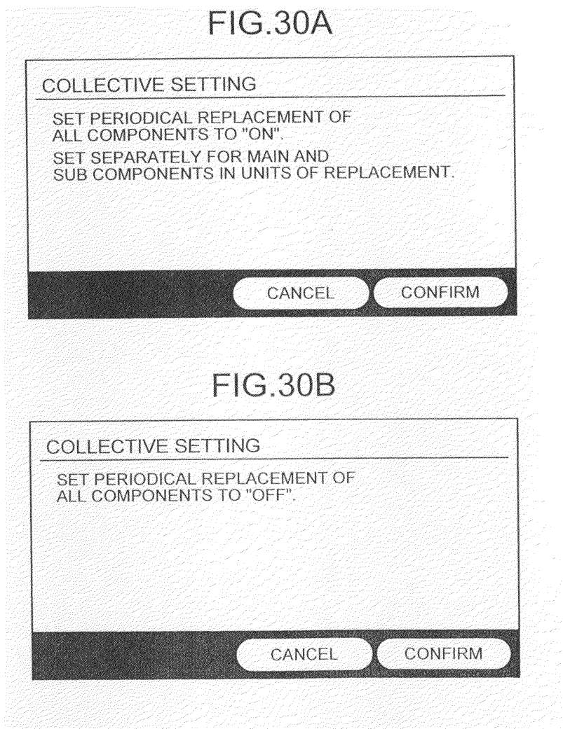

When a process routine as shown in FIG. 29 starts, the CPU 105 first confirms the execution on an execution confirmation screen as shown in FIG. 30A or 30B, at Step S191.

When the execution is canceled as a result of the determination, the CPU 105 ends the process. When OK is selected, the CPU 105 determines a collective setting value to be updated with, at Step S192.

When the collective setting value to be updated with is “OFF” (when the corresponding value is to be updated with “OFF”), the CPU 105 performs the periodical-replacement update process (C) as shown in FIG. 21 to each of the components (including the main and sub components) at Step S193, thereby updating the value with “OFF”. When determining that update of all components is completed at Step S194, the CPU 105 ends the process.

When the collective setting value to be updated with is “ON” (when the corresponding value is to be updated with “ON”), the CPU 105 determines whether each of the components is a main component at Step S195, and does not update the value of the main component.

When the component is not a main component, the CPU 105 determines whether the component is a sub component at Step S196, and does not update the value of the sub component.

When the component is neither a main component nor a sub component, the CPU 105 performs the periodical-replacement update process (C) as shown in FIG. 21 at Step S197, thereby updating the value with “ON”. When determining that update of all the components is completed at Step S198, the CPU 105 ends the process.

FIGS. 30A and 30B are schematic diagrams of examples of notification for confirming execution displayed when the periodical-replacement collective setting is selected.

FIG. 30A depicts an example of an execution confirmation screen displayed when periodical-replacement collective setting “ON” is selected. FIG. 30B depicts an example of the execution confirmation screen displayed when the periodical-replacement collective setting “OFF” is selected. These execution confirmation screens are displayed for the execution confirmation at Step S191 in FIG. 29.

FIG. 31 is flowchart of an example of a subroutine of the replacer collective-setting process at Step S184 in FIG. 28.

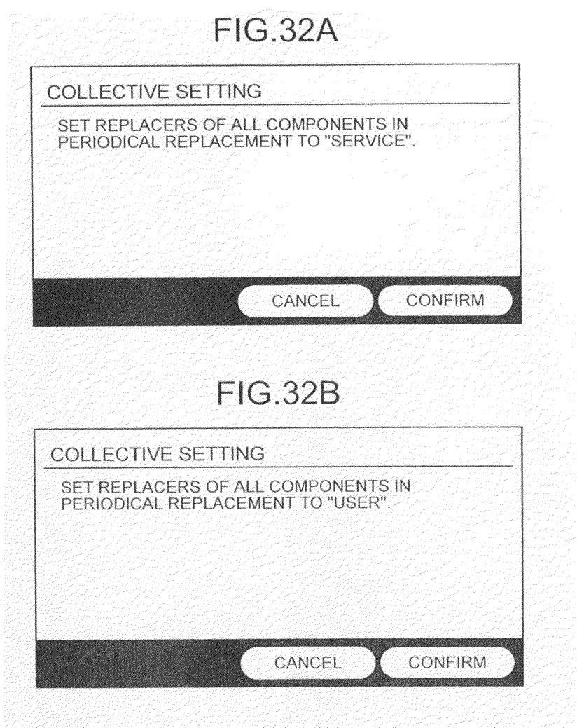

When a process routine as shown in FIG. 31 starts, the CPU 105 first confirms execution on an execution confirmation screen as shown in FIG. 32A or 32B at Step S201.

When the execution is canceled as a result of the confirmation, the CPU 105 ends the process.

When OK is selected as a result of the confirmation of the execution, the CPU 105 checks periodical replacement setting of each component with reference to the setting information at Step S202.

When the periodical replacement setting is “ON”, the CPU 105 updates the replacer in the setting information with a specified value at Step S203.

When the periodical replacement setting is “OFF”, the CPU 105 does not perform the setting of the replacer because this is not a component to be periodically replaced. When determining that update of all components is completed at Step S204, the CPU 105 ends the process.

FIGS. 32A and 32B are schematic diagrams of examples of notification for confirming execution displayed when replacer collective setting is selected.

FIG. 32A depicts an example of an execution confirmation screen displayed when the replacer collective setting “service” is selected. FIG. 32B depicts an example of the execution confirmation screen displayed when the replacer collective setting “user” is selected. These execution confirmation screens are displayed for the execution confirmation at Step S201 in FIG. 31.

FIG. 33 is a flowchart of an example of a subroutine of the replacement-unit collective-setting process at Step S185 in FIG. 28.

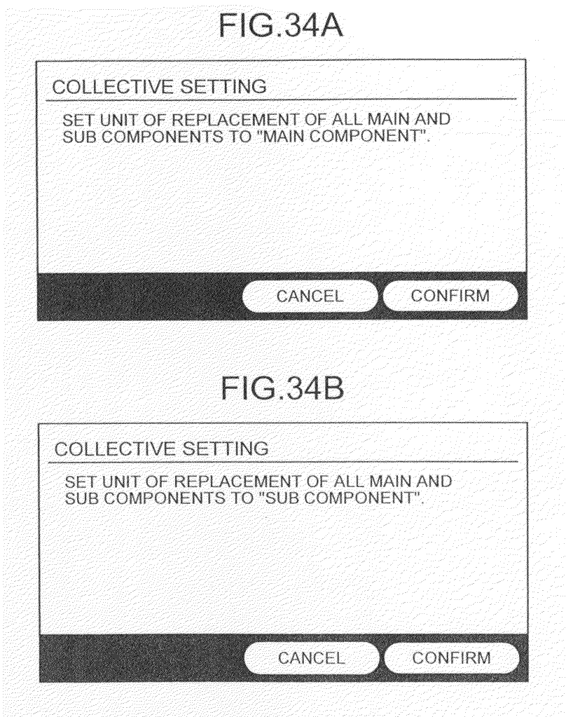

When a process routine as shown in FIG. 33 starts, the CPU 105 first confirms execution on an execution confirmation screen as shown in FIG. 34A or 34B, at Step S211.

When the execution is canceled as a result of the confirmation, the CPU 105 ends the process.

When OK is selected as a result of the confirmation, the CPU 105 determines a collective setting value to be updated with, at Step S212.

When the collective setting value to be updated with is “main component”, the CPU 105 determines whether each of the components is a main component at Step S213. When the component is a main component, the CPU 105 performs the periodical-replacement update process (C) as shown in FIG. 21, thereby updating the value with “ON”, at Step S217.

When the component is not a main component, the CPU 105 determines whether the component is a sub component at Step S214. When the component is a sub component, the CPU 105 performs the periodical-replacement update process (C) as shown in FIG. 21, thereby updating the value with “OFF”, at Step S215.

When the component is neither a main component nor a sub component, the CPU 105 performs nothing.

When determining that update of all the components is completed at Step S216, the CPU 105 ends the process.

When the collective setting value to be updated with is “sub component”, the CPU 105 determines whether each of the components is a sub component at Step S218. When the component is a sub component, the CPU 105 performs the periodical-replacement update process (C) as shown in FIG. 21, thereby updating the value with “ON”, at Step S222.

When the component is not a sub component, the CPU 105 determines whether the component is a main component at Step S219. When the component is a main component, the CPU 105 performs the periodical-replacement update process (C) as shown in FIG. 21, thereby updating the value with “OFF”, at Step S220.

When the component is neither a main component nor a sub component, the CPU 105 performs nothing.

When determining that update of all the components is completed at Step S221, the CPU 105 ends the process.

FIGS. 34A and 34B are schematic diagrams of examples of notification for confirming execution, displayed when the replacement-unit collective setting is selected.

FIG. 34A depicts an example of an execution confirmation screen displayed when the replacement-unit collective setting “main component” is selected. FIG. 34B depicts an example of an execution confirmation screen displayed when the replacement-unit collective setting “sub component” is selected. These execution confirmation screens are displayed for the execution confirmation at Step S211 in FIG. 33.

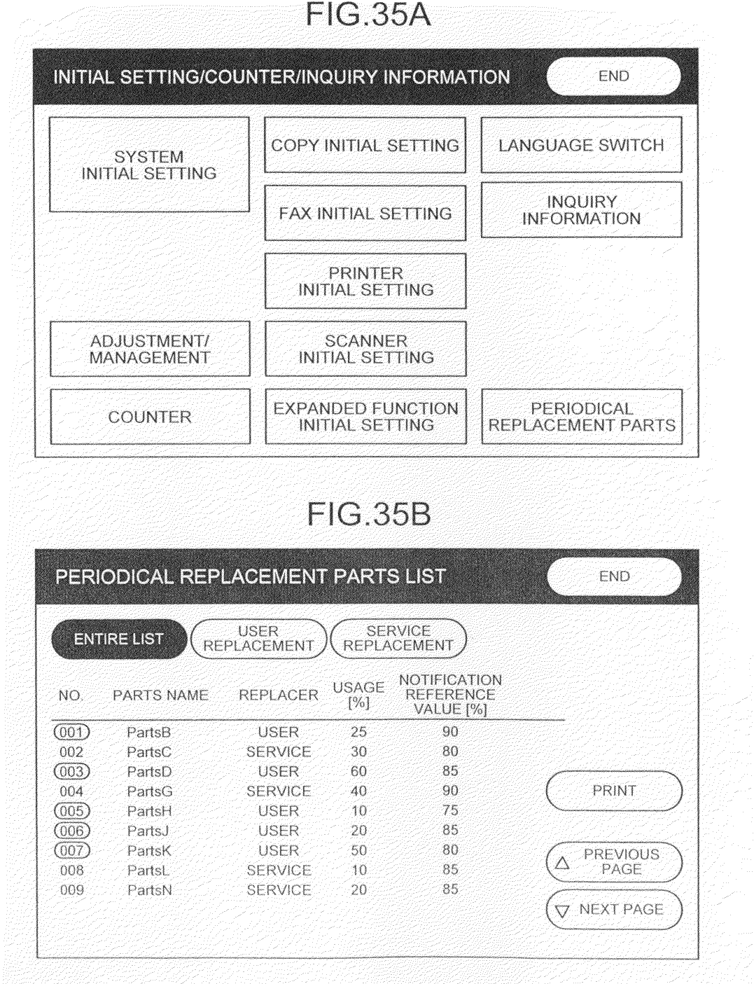

FIGS. 35A to 35D are schematic diagrams of examples of an initial-setting menu screen and a plurality of periodical-replacement-parts list screens, displayed on the operating unit 102 shown in FIG. 1.

When “periodical replacement parts” is selected from the initial-setting menu screen as shown in FIG. 35A, a periodical-replacement-parts list screen as shown in FIG. 35B is displayed.

Views can be switched by selecting any of “entire list”, “user replacement”, and “service replacement”.

When “entire list” is selected, all periodical replacement components are displayed, as shown in FIG. 35B.

When “user replacement” is selected, only components that are to be replaced by the user are displayed as shown in FIG. 35C.

When “service replacement” is selected, only components that are to be replaced by the service engineer are displayed as shown in FIG. 35D.

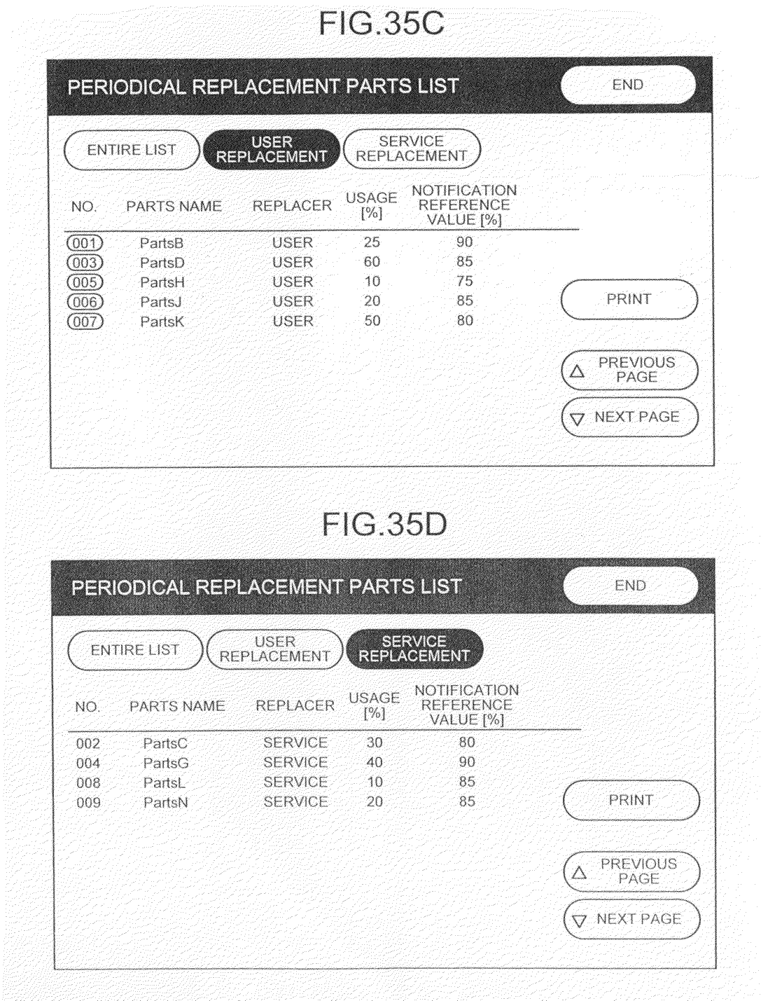

FIG. 36 is a setting information table in consideration of periodical-replacement-parts list screen display, stored in the apparatus as setting information as one example.

This setting information table corresponds to the setting information as shown in FIGS. 35A to 35D.

To only components the periodical replacement of which is set to “ON”, “replacement part numbers” are allocated, and only the components to which the replacement part numbers are allocated are displayed on the periodical-replacement-parts list screen. Information of the components the periodical replacement of which is set to “OFF” is not displayed because the information is unnecessary for the user.

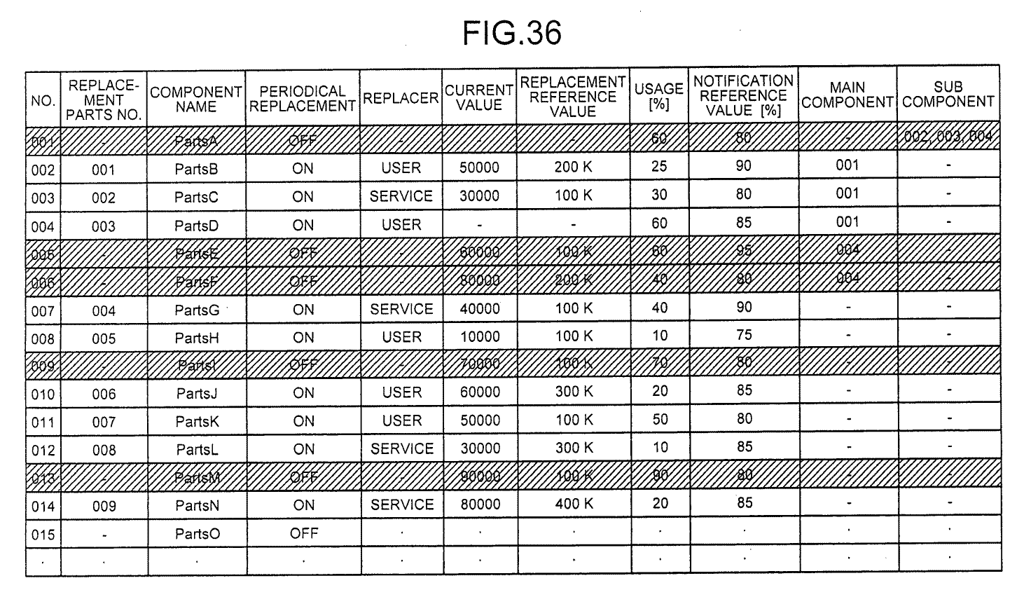

FIGS. 37A to 37C are schematic diagrams of examples of a periodical-replacement-parts list screen and a plurality of setting screens, displayed on the operating unit 102 shown in FIG. 1.

When a component “PartsB” is selected for example on the periodical-replacement-parts list screen as shown in FIG. 37A, the setting screen as shown in FIG. 37B is displayed.

On the setting screen, “complete replacement” or “change the notification reference value (value for notifying a near end)” can be selected.

When “report setting” is selected on the periodical-replacement-parts list screen as shown in FIG. 37A, a report setting screen as shown in FIG. 37C is displayed, thereby allowing automatic ordering of a selected component. More specifically, when “automatic ordering” on the report setting screen is set to “ON”, the selected component is automatically ordered to the managing apparatus in the service center when the usage reaches the notification reference value.

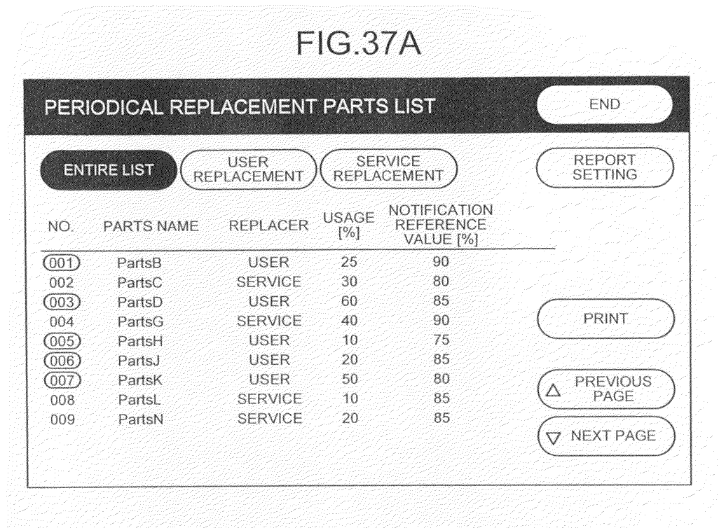

FIG. 38 is a flowchart of an example of a user-setting menu process performed by the CPU 105 shown in FIG. 1.

When “periodical replacement parts” is selected from the initial-setting menu screen, the CPU 105 starts a process routine as shown in FIG. 38, and first sets an initial value of a display mode to “entire list” at Step S231.

The CPU 105 obtains information from the setting information table according to the display mode, to display a list of the information as a periodical-replacement-parts list screen at Step S232. For example, the periodical-replacement-parts list screen as shown in FIG. 35B is displayed. The current value and the replacement reference value are not displayed in the list for the user. This is because the current values and the replacement reference values vary according to components, and therefore the replacement times are hard to determine. To easily determine the replacement times, the usages (%) are displayed. Setting buttons are selectable only for the user replacement components.

The system control then proceeds to Step S233 and the CPU 105 determines a process selected on the periodical-replacement-parts list screen (any of “component selection”, “report setting”, and “view switching”).

When a result of the determination indicates that the selected process is “view switching”, the CPU 105 updates the display mode at Step S235.

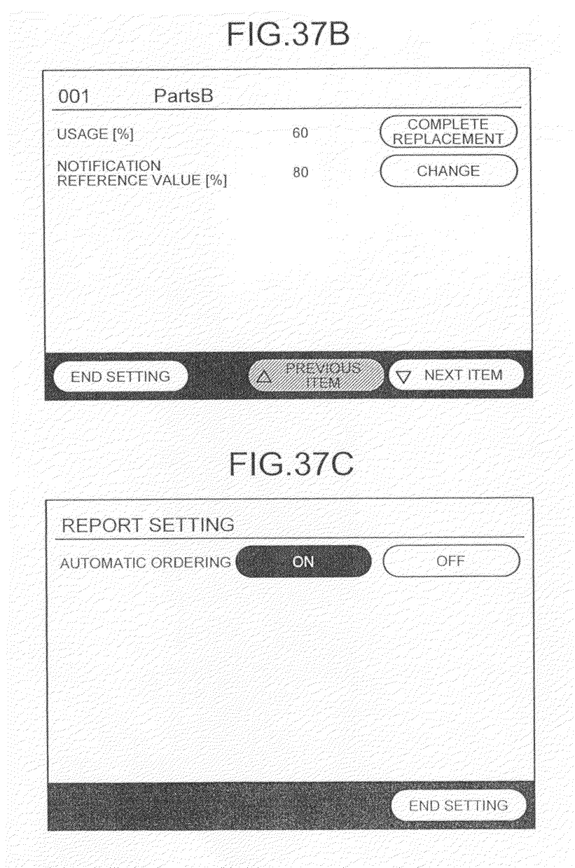

When the selected process is “report setting”, the CPU 105 performs a report setting process as shown in FIG. 39 at Step S236.

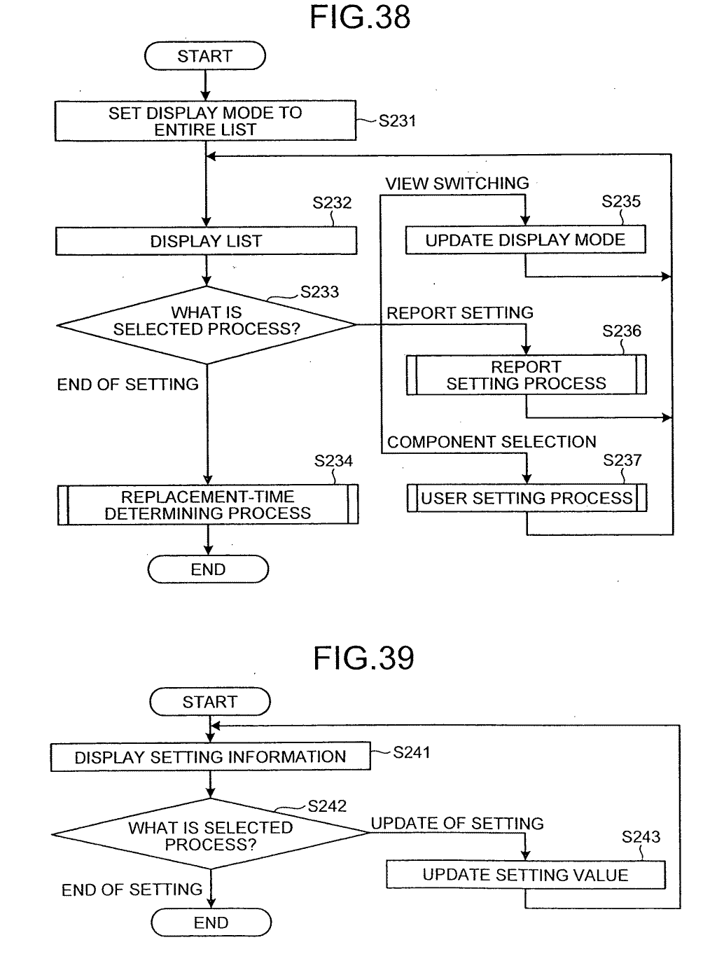

When the selected process is “component selection”, the CPU 105 performs a user setting process as shown in FIG. 40 at Step S237.

Upon completion of the display-mode update process at Step S235, the report setting process at Step S236, or the user setting process at Step S237, the CPU 105 displays a list of the information (the periodical-replacement-parts list screen) again to reflect updated information, at Step S232.

When “end of setting” is selected upon completion of setting of all the components, the CPU 105 performs the replacement-time determining process as shown in FIG. 11 at Step S234, and ends the process.

FIG. 39 is a flowchart of an example of a subroutine of the report setting process at Step S236 in FIG. 38.

When the report setting is selected in the user-setting menu process as shown in FIG. 38, the CPU 105 starts a process routine as shown in FIG. 39. The CPU 105 first obtains corresponding information from the setting information table to display a setting screen indicating current setting information, for example, the setting screen as shown in FIG. 37C, at Step S241.

The system control then proceeds to Step S242 and the CPU 105 determines a process selected on the setting screen.

When a result of the determination indicates that the selected process is “update of setting”, the CPU 105 updates the setting value at Step S243. Upon completion of the update process of the setting value, the CPU 105 displays again the setting information (setting screen) to reflect the updated information, at Step S241.

When “end of setting” is selected upon completion of the setting, the CPU 105 ends the process.

FIG. 40 is a flowchart of an example of a subroutine of the user setting process at Step S237 in FIG. 38.

When a component is selected in the user-setting menu process shown in FIG. 38, the CPU 105 starts a process routine as shown in FIG. 40. The CPU 105 first obtains corresponding information from the setting information table, and displays a setting screen indicating the current setting information, for example, the setting screen as shown in FIG. 37B, at Step S251.

The system control then proceeds to Step S252 and the CPU 105 determines a process selected on the setting screen.

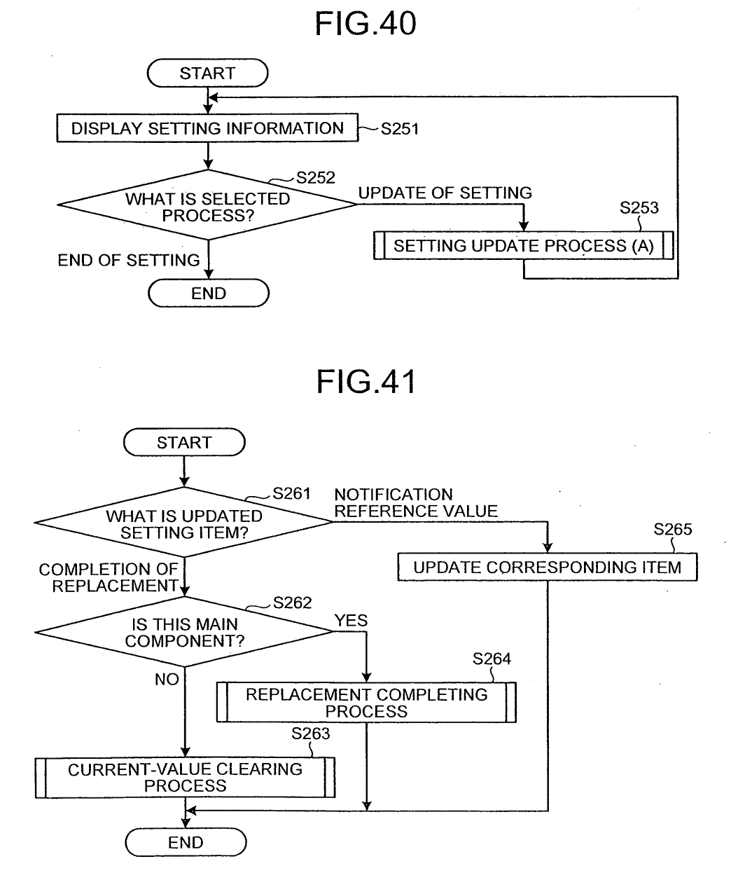

When a result of the determination indicates that the selected process is “update of setting”, the CPU 105 performs a setting update process (A) as shown in FIG. 41, at Step S253. Upon completion of the setting update process, the CPU 105 displays again the setting information (setting screen) to reflect the updated information, at Step S251.

When “end of setting” is selected upon completion of the setting, the CPU 105 ends the process.

FIG. 41 is a flowchart of an example of a subroutine of the setting update process (A) at Step S253 in FIG. 40.

When this process routine starts, the CPU 105 first determines an updated setting item, at Step S261.

When a result of the determination indicates that the updated setting item is completion of replacement (when completion of replacement is selected), the CPU 105 determines whether a selected component is a main component (whether there is any sub component), at Step S262.

When the selected component is not a main component, the CPU 105 performs the current-value clearing process as shown in FIG. 9 by issuing an instruction to the usage managing module 202, at Step S263.

When the selected component is a main component, the CPU 105 performs the replacement completing process as shown in FIG. 24 by issuing an instruction to the usage managing module 202, at Step S264.

When the updated setting item is the notification reference value (when the notification reference value is updated), the CPU 105 updates the notification reference value in the setting information at Step S265.

As described above, the CPU 105 of the controller 200 performs the setting in the replacement operation method (periodical replacement/replacement at failure) as to whether each of the replacement components in the engine 101 is to be replaced at the failure or replaced periodically, and the setting of the corresponding replacer (service engineer/user) of the replacement component according to an operation through the operating unit 102. The CPU 105 then stores and registers the setting information in the nonvolatile memory. Therefore, services, which are most suitable for the operation manner of the user, the country, or the region, can be provided.

A computer program according to any of the present embodiments is for causing a computer (CPU) that controls an image forming apparatus to realize the functions as the setting unit (including the replacement-time setting unit), the information registering unit (including the usage registering unit, and the replacement-time determining unit), the usage detecting unit, the communication establishing unit, and the information notifying unit. By causing the computer to execute such a computer program, the effect as described above can be achieved.

Such a computer program can be stored in a storage unit such as a ROM and a HDD in advance. The computer program can be provided being recorded in a recording medium such as a compact disk read only memory (CD-ROM), a flexible disk (FD), a magneto-optical (MO) disk, a compact disk recordable (CD-R), a compact disk rewritable (CD-RW), a digital versatile disk recordable (DVD+R, DVD-R), a DVD rewritable (DVD+RW, DVD-RW), and a DVD random access memory (DVD-RAM), or a nonvolatile recording medium (memory) such as an electrically erasable and programmable read only memory (EEPROM), and a memory card. By installing the computer program recorded in the nonvolatile recording medium in an image forming apparatus and causing a CPU to execute the computer program, or by causing the CPU to read the computer program from the nonvolatile recording medium and execute the computer program, the procedures as described above can be performed.

Furthermore, the computer program can be executed by being downloaded from an external device connected to a network and having a recording medium that stores therein the computer program, or from an external device connected to a network and including a storage unit that stores therein the computer program.

According to an aspect of the present invention, setting as to whether each of plural replacement components in an image forming apparatus is to be replaced at the failure or replaced periodically, and setting of the corresponding replacer (service engineer or user) of the replacement component is performed, and the setting information is registered in the image forming apparatus. Accordingly, it is possible to provide services most appropriate for an operation manner of the user, the country, or the region.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus including a plurality of replacement components, the image forming apparatus comprising:
a information setting unit that sets a replacement type of each of the replacement components, which indicates whether each of the replacement components is to be replaced at failure or replaced periodically, and a replacer who is in charge of replacing each of the replacement components; and
an information registering unit that registers therein the replacement type and the replacer set by the information setting unit for each of the replacement components.

2. The image forming apparatus according to claim 1, further comprising a usage detecting unit that detects usage of each of the replacement components, wherein
the information registering unit includes a usage registering unit that registers therein the usage of each of the replacement components detected by the usage detecting unit.

3. The image forming apparatus according to claim 2, wherein
each of the replacement components includes a plurality of sub components,
the usage registering unit registers therein usage of a sub component that has been most used among sub components constituting a replacement component as the usage of the replacement component.

4. The image forming apparatus according to claim 3, wherein the sub components include sub components physically or functionally included in the replacement component.

5. The image forming apparatus according to claim 4, wherein
the information setting unit includes a replacement-time setting unit that sets a replacement time for each of the replacement components,
the replacement-time setting unit performs setting of the replacement time for a replacement component that is set to be replaced periodically, in units of replacement component or in units of sub component, and
the information registering unit further selects a earliest replacement time from among replacement times set for the sub components physically or functionally included in the replacement component that is set to be replaced periodically by the information setting unit, and determines a selected replacement time as the replacement time for the replacement component.

6. The image forming apparatus according to claim 5, wherein when a replacement component is set to be replaced periodically, the information setting unit also sets sub components physically or functionally included in the replacement component to be replaced periodically.

7. The image forming apparatus according to claim 5, wherein the usage detecting unit includes a usage-level detecting unit that detects whether the usage of each of the replacement components reaches a preset reference value.

8. The image forming apparatus according to claim 7, wherein the information setting unit includes a reference setting unit that sets the preset reference value in units of replacement component or in units of sub component.

9. The image forming apparatus according to claims 5, wherein the information setting unit includes a replacer setting unit that sets a replacer for each of the replacement components and each of the sub components.

10. The image forming apparatus according to claims 5, further comprising:
a communication establishing unit that establishes a communication with an external device;
an information notifying unit that notifies the external device of information related to the usage of each of the replacement components detected by the usage detecting unit and the replacement time for each of the replacement components set by the replacement-time setting unit.

11. A method of registering information of a replacement component in an image forming apparatus that includes a plurality of replacement components, the method comprising:
setting a replacement type of each of the replacement components, which indicates whether each of the replacement components is to be replaced at failure or replaced periodically, and a replacer who is in charge of replacing each of the replacement components; and
registering the replacement type and the replacer set at the setting for each of the replacement components.

12. A computer program product comprising a computer-usable medium having computer-readable program codes embodied in the medium for registering information of a replacement component in an image forming apparatus that includes a plurality of replacement components, the program codes when executed causing a computer to execute:
information setting including setting a replacement type of each of the replacement components, which indicates whether each of the replacement components is to be replaced at failure or replaced periodically, and a replacer who is in charge of replacing each of the replacement components; and
information registering including registering the replacement type and the replacer set at the information setting for each of the replacement components.

13. The computer program product according to claim 12, wherein the program codes further causes the computer to execute detecting usage of each of the replacement components, wherein
the information registering further includes registering the usage of each of the replacement components detected at the detecting.

14. The computer program product according to claim 13, wherein
each of the replacement components includes a plurality of sub components,
the information registering further includes registering usage of a sub component that has been most used among sub components constituting a replacement component as the usage of the replacement component.

15. The computer program product according to claim 14, wherein the sub components include sub components physically or functionally included in the replacement component.

16. The computer program product according to claim 15, wherein
the information setting further includes setting a replacement time for each of the replacement components,
the setting a replacement time further includes setting a replacement time for a replacement component that is set to be replaced periodically, in units of replacement component or in units of sub component, and
the information registering further includes
selecting a earliest replacement time from among replacement times set for the sub components physically or functionally included in the replacement component that is set to be replaced periodically at the information setting, and
determining a selected replacement time as the replacement time for the replacement component.

17. The computer program product according to claim 16, wherein when a replacement component is set to be replaced periodically, the information setting further includes setting the sub components physically or functionally included in the replacement component to be replaced periodically.

18. The computer program product according to claim 16, wherein the detecting includes detecting whether the usage of each of the replacement components reaches a preset reference value.

19. The computer program product according to claim 18, wherein the information setting further includes setting the preset reference value in units of replacement component or in units of sub component.

20. The computer program product according to claim 16, wherein the information setting further includes setting a replacer for each of the replacement components and each of the sub components.
